(19) United States
(12) Patent Application Publication
(10) Pub. No.: US 2009/0112687 A1
(43) Pub. Date: Apr. 30, 2009

(54) SYSTEM AND METHOD FOR DEVELOPING AND MANAGING ADVERTISEMENT CAMPAIGNS

(75) Inventors: Jason A. Blair, Billings, MT (US); Alton T. Crossley, Billings, MT (US); Josh King, Billings, MT (US); Michael William Glennon Unquera, Billings, MT (US)

Correspondence Address: ANTOINETTE M. TEASE, P. O. BOX 51016, BILLINGS, MT, 59105, US

(73) Assignee: Dealerspan, LLC, Billings, MT (US)

(21) Appl. No.: 11/929,128

(22) Filed: Oct. 30, 2007

(51) Int. Cl. G06F 17/30; G06Q 30/00

(52) U.S. Cl. 705/10; 705/14; 705/30

(57) ABSTRACT

A system for developing and managing advertisement campaigns comprising an ad development module; a campaign development module; an inventory control module; a messaging module; a prospect event tracking module; and a central data store; wherein the campaign development module allows users to create new ad campaigns; wherein the ad development module enables users to create new advertisements; wherein the inventory control module allows a user to search for vehicles that meet certain criteria and to view data on selected vehicles; wherein the messaging module manages communications within a dealership, between the dealership and customers, and between the dealership and vendors; and wherein the prospect event tracking module links prospective buyers to interactions with the dealership. A method of using the above system to develop and manage advertisement campaigns.

### BACKGROUND OF THE INVENTION

1. Field of the Invention

The present invention relates generally to the field of computer-implemented inventions, and more specifically, to a system and method for managing advertisement campaigns.

2. Description of the Related Art

The internet and the attendant availability of information have empowered consumers, expanding their buying market and increasing their leverage in the purchasing process by providing them with data on availability and pricing. Automobile dealerships, sometimes from wide geographical areas, are competing for increasingly savvy consumers and must find ways to differentiate themselves: to the customers through service and pricing, and within the industry through increased efficiency.

Dealerships have not yet been able to take advantage of the technological advances. Far from using information to help them compete, dealerships' information systems are barriers to more effective operations. Dealerships have approached the automation and computerization problem piecemeal, installing individual pieces of software and hardware for the separate steps in the operational process. Offerings from vendors have historically been focused, addressing a narrow problem with a narrow solution. This situation directly affects dealerships' profitability, incurring the expense of subscription fees for multiple software applications, and purchase and maintenance costs for the machines on which those applications reside.

More important is the effect of this lack of integration on efficiency. Dealership personnel have to master multiple disconnected applications and platforms, as well as provide the manual linkage between the systems, resulting in a drag on their productivity. For example, completing the sale of a vehicle involves inventory control, deal structuring and financing applications, and manual transfer and re-keying of information between them. The same data is captured and re-entered multiple times for a single sale, wasting time, risking error and frustrating customers.

These unconnected applications create unconnected pockets of data. Rather than providing leverage to increase profits and productivity, these pockets of data further hamper operations. Users have to go to multiple systems to acquire the data they need. The data conflict or overlap, and users must bear the expense and effort of reconciling the multiple sources of data to figure out which piece of data is the one they need.

One of the areas where the problem of multiple unintegrated front-end systems is particularly evident is in advertising, that is, the compilation, building, running and analyzing of ads. Sales managers spend 15-20 hours of their work week developing ads and getting them published. It is a manual process that is time-consuming and error-prone. Dealers must identify the individual cars to include, collect the specifications for each vehicle by accessing the inventory control system—one car at a time—and collect or create media to be displayed with the ad. This latter step often involves simply taking pictures of the included vehicles.

Some vehicles may receive pricing specific to the ad, and the pricing process is often an ad hoc activity performed with poor information as to the potential profitability of the sale. Further, if the new pricing information is not subsequently entered into the system or systems that sales people on the floor use, there may be inconsistencies between the prices quoted on the floor and those reflected in the ad. Customer dissatisfaction, damage to the dealership's reputation and lawsuits can result.

Furthermore, as is often the case with processes in which many pieces of data must change hands, a necessary component of the ad package might be forgotten and the process halted until the bundle is complete. For representatives of the advertising agency who often pick up the ad package and hand deliver the proofs, this can mean another round trip to the dealership.

The point of all of this effort and expense is to bring prospects into the dealership, in person or electronically, and to sell them a car. Dealerships spend, on average, eight to ten percent of their income from gross sales on advertising. The fundamental shortcoming of the lack of integration and dearth of dependable data is that the dealership has no way of analyzing the effectiveness of the advertising in achieving its goal.

What is needed is a software application that increases efficiency and decreases costs associated with placing advertising campaigns. Furthermore, what is needed is a software application that enables dealerships to track the efficiency of their advertising campaigns so that they can make determinations as to whether their advertising dollars are being wisely spent and reallocate those dollars to campaigns that provide a greater return on investment.

### BRIEF SUMMARY OF THE INVENTION

The present invention is a system for developing and managing advertisement campaigns comprising: (a) an ad development module; (b) a campaign development module; (e) an inventory control module; (d) a messaging module; (e) a prospect event tracking module; and (f) a central data store; wherein each module accesses the central data store; wherein the central data store comprises data on vehicles in inventory, existing customers, prospective buyers, advertisements and advertisement campaigns, contacts, communications, and marketing and/or sales materials from manufacturers; wherein the campaign development module allows users to create new ad campaigns; wherein the ad development module enables users to create new advertisements; wherein the inventory control module allows a user to search for vehicles that meet certain criteria and to view data on selected vehicles; wherein the messaging module manages communications within a dealership, between the dealership and customers, and between the dealership and vendors; and wherein the prospect event tracking module links prospective buyers to interactions with the dealership.

In a preferred embodiment, the central data store comprises an administration database, one or more dealership databases, and one or more databases containing data that is common across dealerships; the dealership databases contain data that is specific to a particular dealership; the common databases comprise a media database and a third party application support database; and each dealership implements its own dealership database to ensure complete separation of all business data from other dealerships. Preferably, each ad is associated with a particular campaign; and each campaign is assigned a campaign code. The campaign code is used to link prospective buyers to the ads that introduced them to the dealership. Preferably, each prospective buyer is assigned a customer identifier; and the campaign codes and prospect events are stored in the dealership database and linked by the customer identifiers.

In a preferred embodiment, to create a new ad, the user selects a campaign, selects the vehicles to be included in the ad, selects an ad contact, specifies a time period over which an ad is to be run, enters an estimated cost for the ad, enters comments and/or instructions regarding production of the ad, and saves the ad as a new ad. Preferably, once the new ad is saved, it is written to the dealership database; when a new ad is saved, the system automatically generates a new ad message that is posted to a web messaging page; when a new ad is saved, the system automatically generates an ad identifier and a new ad message identifier; and when a new ad is saved, the system automatically sends an email to the ad contact with the address for the web messaging page on which the new ad message is posted.

In a preferred embodiment, a web messaging page is created for each new ad; the ad comprises contents and a design, and the web messaging page allows the user and the ad contact to communicate with each other regarding the ad contents and design by posting messages to the web messaging page; the ad identifier and the new ad message identifier are used to generate the address for the web messaging page; and all messages concerning the ad are assigned identifiers related to the new ad message identifier and stored in the dealership database. Preferably, the new ad message comprises a campaign code, the address for the web messaging page, an estimated cost of the new ad, and comments and/or instructions regarding the contents and/or design of the ad; and a file comprising a list of the vehicles to be included in the ad is attached to the new ad message. The marketing and/or sales materials from manufacturers are preferably attached to the new ad message.

In a preferred embodiment, the ad contact reviews the new ad message, produces a proof of the ad, and posts a message with the proof attached to the message on the web messaging page; the user reviews and approves or declines the proof and if the proof is declined, provides reasons for declining; an iterative process continues until the ad is approved; when the ad is approved, if the ad contact is a media vendor, then the system sends an email with the approved proof to the ad contact; and when the ad is approved, if the ad contact is not a media vendor, then the system sends an approval notification to the ad contact and an email with the approved proof to a contact at the media vendor for publication or airing of the ad. Preferably, the system further comprises a new budget entry page, wherein when an ad is approved, the system automatically assigns an approval date to the ad; wherein the estimated cost of the ad and the approval date are modifiable; wherein the user enters a total budgeted amount for advertising on the new budget entry page; wherein the cost of ads whose approval dates are within a dealership's fiscal year are deducted from the total budgeted amount to generate a net amount; and wherein the net amount is reflected on a campaign summary page of the campaign development module.

In a preferred embodiment, a cost is associated with each campaign, and the cost of a campaign is calculated by querying the dealership database for all ads associated with a particular campaign code. Preferably, the system allows the user to calculate the costs associated with one or more campaigns by media, media type and/or vendor.

In a preferred embodiment, the system allows a dealership to link customers to prospect events, customers to campaign codes, campaign codes to ads, ads to advertising costs, and campaign codes to media/type/vendor data; and the media data represents the media in which an ad appears, the type data is a sub-class of media, and the vendor data reflects the media vendor.

In a preferred embodiment, the campaign development module comprises a campaign summary page; a media vendor is associated with each campaign, and wherein the campaign summary page identifies the media vendor; the campaign summary page identifies a media type, campaign code, vendor contact and dealership location for each campaign; the user can create a new campaign, edit an existing campaign, create a new ad, or delete a campaign from the campaign summary page; if the user elects to create a new campaign, a new campaign process is called; the new campaign process assists users in defining new campaigns; and the new campaign process comprises one or more pages that guide the user through the definition of a new campaign.

In a preferred embodiment, the ad development module comprises an ad list page; the ad list page lists all ads that have been approved; users can screen ads by start and end dates and/or ad status; and ad status is current, pending or expired. Preferably, the ad development module comprises an ad list page and an ad details page; the campaign development module comprises a campaign summary page; the ad details page is called when the user selects a specific ad on the ad list page or the campaign summary page; the ad details page comprises an ad details section, a dates and approvals section, a messaging section, and an inventory section; and the messaging section shows the initial new ad message from the dealership to the ad contact and all subsequent messages related to the initial new ad message.

In a preferred embodiment, the ad development module comprises a new ad page; the new ad page assists users in defining new ads to be included in a campaign; the user selects vehicles to be included in the new ad; the vehicles are selected by search, from a cart and/or from inventory; the user inputs start and end dates for the new ad; the user associates the ad with a campaign; the user enters an estimated cost for the ad; the user selects an ad contact; and each ad comprises contents and/or design, the user enters comments and/or instructions concerning the contents and/or design of the ad. Preferably, if the user elects to select vehicles from inventory, the system calls an inventory details page; the inventory details page comprises a cart section, a search section, a vehicle listing section, and a vehicle detail section; and the user can add vehicles to the cart from the inventory details page. Preferably, the inventory details page displays a base cost and a manufacturer's suggested retail price for each vehicle; the inventory details page allows a user to input markup, rebate and discount amounts; and the system calculates a sales price for the vehicle.

In a preferred embodiment, the system further comprises a mini-desk calculation window that allows the user to calculate payment based on sales price, down payment and financing interest rate and term.

In a preferred embodiment, the vehicle detail section of the inventory details page comprises a valuation subsection and a profit center subsection; the valuation subsection displays vehicle valuation figures from third party sources; and the profit center subsection allows the user to calculate the potential profit associated with a particular transaction.

The present invention is also a system for developing and managing advertisement campaigns comprising: (a) an ad development module; (b) a campaign development module; (c) an inventory control module; (d) a messaging module; (e) a prospect event tracking module; and (f) a central data store; wherein each module accesses the central data store; wherein the central data store comprises data on products in inventory, existing customers, prospective buyers, advertisements and advertisement campaigns, contacts, communications, and marketing and/or sales materials from manufacturers; wherein the campaign development module allows users to create new ad campaigns; wherein the ad development module enables users to create new advertisements; wherein the inventory control module allows a user to search for products that meet certain criteria and to view data on selected products; wherein the messaging module manages communications within a sales entity, between the sales entity and customers, and between the sales entity and vendors; and wherein the prospect event tracking module links prospective buyers to interactions with the sales entity.

In a preferred embodiment, the central data store comprises an administration database, one or more sales entity databases, and one or more databases containing data that is common across sales entities; the sales entity databases contain data that is specific to a particular sales entity; the common databases comprise a media database and a third party application support database; and each sales entity implements its own sales entity database to ensure complete separation of all business data from other sales entities. Preferably, each ad is associated with a particular campaign; and each campaign is assigned a campaign code. The campaign code is used to link prospective buyers to the ads that introduced them to the sales entity. Preferably, each prospective buyer is assigned a customer identifier; and the campaign codes and prospect events are stored in the sales entity database and linked by the customer identifiers.

In a preferred embodiment, to create a new ad, the user selects a campaign, selects the products to be included in the ad, selects an ad contact, specifies a time period over which an ad is to be run, enters an estimated cost for the ad, enters comments and/or instructions regarding production of the ad, and saves the ad as a new ad. Preferably, once the new ad is saved, it is written to the sales entity database; when a new ad is saved, the system automatically generates a new ad message that is posted to a web messaging page; when a new ad is saved, the system automatically generates an ad identifier and a new ad message identifier; and when a new ad is saved, the system automatically sends an email to the ad contact with the address for the web messaging page on which the new ad message is posted.

In a preferred embodiment, a web messaging page is created for each new ad; the ad comprises contents and a design, and the web messaging page allows the user and the ad contact to communicate with each other regarding the ad contents and design by posting messages to the web messaging page; the ad identifier and the new ad message identifier are used to generate the address for the web messaging page; and all messages concerning the ad are assigned identifiers related to the new ad message identifier and stored in the sales entity database. Preferably, the new ad message comprises a campaign code, the address for the web messaging page, an estimated cost of the new ad, and comments and/or instructions regarding the contents and/or design of the ad; and a file comprising a list of the products to be included in the ad is attached to the new ad message. The marketing and/or sales materials from manufacturers are preferably attached to the new ad message.

In a preferred embodiment, the ad contact reviews the new ad message, produces a proof of the ad, and posts a message with the proof attached to the message on the web messaging page; the user reviews and approves or declines the proof, and if the proof is declined, provides reasons for declining; an iterative process continues until the ad is approved; when the ad is approved, if the ad contact is a media vendor, then the system sends an email with the approved proof to the ad contact; and when the ad is approved, if the ad contact is not a media vendor, then the system sends an approval notification to the ad contact and an email with the approved proof to a contact at the media vendor for publication or airing of the ad. Preferably, the system further comprises a new budget entry page, wherein when an ad is approved, the system automatically assigns an approval date to the ad; wherein the estimated cost of the ad and the approval date are modifiable; wherein the user enters a total budgeted amount for advertising on the new budget entry page; wherein the cost of ads whose approval dates are within a sales entity's fiscal year are deducted from the total budgeted amount to generate a net amount; and wherein the net amount is reflected on a campaign summary page of the campaign development module.

In a preferred embodiment, a cost is associated with each campaign, and the cost of a campaign is calculated by querying the sale entity database for all ads associated with a particular campaign code. Preferably, the system allows the user to calculate the costs associated with one or more campaigns by media, media type and/or vendor.

In a preferred embodiment, the system allows a sales entity to link customers to prospect events, customers to campaign codes, campaign codes to ads, ads to advertising costs, and campaign codes to media/type/vendor data; and the media data represents the media in which an ad appears, the type data is a sub-class of media, and the vendor data reflects the media vendor.

In a preferred embodiment, the campaign development module comprises a campaign summary page; a media vendor is associated with each campaign, and wherein the campaign summary page identifies the media vendor; the campaign summary page identifies a media type, campaign code, vendor contact and sales entity location for each campaign; the user can create a new campaign, edit an existing campaign, create a new ad, or delete a campaign from the campaign summary page; if the user elects to create a new campaign, a new campaign process is called; the new campaign process assists users in defining new campaigns; and the new campaign process comprises one or more pages that guide the user through the definition of a new campaign.

In a preferred embodiment, the ad development module comprises an ad list page; the ad list page lists all ads that have been approved; users can screen ads by start and end dates and/or ad status; and ad status is current, pending or expired. Preferably, the ad development module comprises an ad list page and an ad details page; the campaign development module comprises a campaign summary page; the ad details page is called when the user selects a specific ad on the ad list page or the campaign summary page; the ad details page comprises an ad details section, a dates and approvals section, a messaging section, and an inventory section; and the messaging section shows the initial new ad message from the sales entity to the ad contact and all subsequent messages related to the initial new ad message.

In a preferred embodiment, the ad development module comprises a new ad page; the new ad page assists users in defining new ads to be included in a campaign; the user selects products to be included in the new ad; the products are selected by search, from a cart and/or from inventory; the user inputs start and end dates for the new ad; the user associates the ad with a campaign; the user enters an estimated cost for the ad; the user selects an ad contact; and each ad comprises contents and/or design, the user enters comments and/or instructions concerning the contents and/or design of the ad. Preferably, if the user elects to select products from inventory, the system calls an inventory details page; the inventory details page comprises a cart section, a search section, a product listing section, and a product detail section; and the user can add products to the cart from the inventory details page. Preferably, the inventory details page displays a base cost and a manufacturer's suggested retail price for each product; the inventory details page allows a user to input markup, rebate and discount amounts; and the system calculates a sales price for the product.

In a preferred embodiment, the system further comprises a mini-desk calculation window that allows the user to calculate payment based on sales price, down payment and financing interest rate and term.

In a preferred embodiment, the product detail section of the inventory details page comprises a valuation subsection and a profit center subsection; the valuation subsection displays vehicle valuation figures from third party sources; and the profit center subsection allows the user to calculate the potential profit associated with a particular transaction.

The present invention is also a method for developing and managing advertisement campaigns comprising: (a) an ad development module; (b) a campaign development module; (c) an inventory control module; (d) a messaging module; (e) a prospect event tracking module; and (f) a central data store; wherein each module accesses the central data store; wherein the central data store comprises data on vehicles in inventory, existing customers, prospective buyers, advertisements and advertisement campaigns, contacts, communications, and marketing and/or sales materials from manufacturers; wherein the campaign development module allows users to create new ad campaigns; wherein the ad development module enables users to create new advertisements; wherein the inventory control module allows a user to search for vehicles that meet certain criteria and to view data on selected vehicles; wherein the messaging module manages communications within a dealership, between the dealership and customers, and between the dealership and vendors; and wherein the prospect event tracking module links prospective buyers to interactions with the dealership.

In a preferred embodiment, the central data store comprises an administration database, one or more dealership databases, and one or more databases containing data that is common across dealerships; the dealership databases contain data that is specific to a particular dealership; the common databases comprise a media database and a third party application support database; and each dealership implements its own dealership database to ensure complete separation of all business data from other dealerships. Preferably, each ad is associated with a particular campaign; and each campaign is assigned a campaign code. The campaign code is used to link prospective buyers to the ads that introduced them to the dealership. Preferably, each prospective buyer is assigned a customer identifier; and the campaign codes and prospect events are stored in the dealership database and linked by the customer identifiers.

In a preferred embodiment to create a new ad, the user selects a campaign, selects the vehicles to be included in the ad, selects an ad contact, specifies a time period over which an ad is to be run, enters an estimated cost for the ad, enters comments and/or instructions regarding production of the ad, and saves the ad as a new ad. Preferably, once the new ad is saved, it is written to the dealership database; when a new ad is saved, a new ad message is automatically generated and posted to a web messaging page; when a new ad is saved, an ad identifier and a new ad message identifier are automatically generated; and when a new ad is saved, an email is automatically sent to the ad contact with the address for the web messaging page on which the new ad message is posted.

In a preferred embodiment, a web messaging page is created for each new ad; the ad comprises contents and a design, and wherein the web messaging page allows the user and the ad contact to communicate with each other regarding the ad contents and design by posting messages to the web messaging page; the ad identifier and the new ad message identifier are used to generate the address for the web messaging page; and all messages concerning the ad are assigned identifiers related to the new ad message identifier and stored in the dealership database. Preferably, the new ad message comprises a campaign code, the address for the web messaging page, an estimated cost of the new ad, and comments and/or instructions regarding the contents and/or design of the ad; and a file comprising a list of the vehicles to be included in the ad is attached to the new ad message. The marketing and/or sales materials from manufacturers are attached to the new ad message.

In a preferred embodiment, the ad contact reviews the new ad message, produces a proof of the ad, and posts a message with the proof attached to the message on the web messaging page; the user reviews and approves or declines the proof, and if the proof is declined, provides reasons for declining; an iterative process continues until the ad is approved; when the ad is approved, if the ad contact is a media vendor, then an email with the approved proof is sent to the ad contact; and when the ad is approved, if the ad contact is not a media vendor, then an approval notification is sent to the ad contact and an email with the approved proof is sent to a contact at the media vendor for publication or airing of the ad. Preferably, the method further comprises providing a new budget entry page, wherein when an ad is approved, an approval date is automatically assigned to the ad; wherein the estimated cost of the ad and the approval date are modifiable; wherein the user enters a total budgeted amount for advertising on the new budget entry page; wherein the cost of ads whose approval dates are within a dealership's fiscal year are deducted from the total budgeted amount to generate a net amount; and wherein the net amount is reflected on a campaign summary page of the campaign development module.

In a preferred embodiment, a cost is associated with each campaign, and the cost of a campaign is calculated by querying the dealership database for all ads associated with a particular campaign code. Preferably, the user has the ability to calculate the costs associated with one or more campaigns by media, media type and/or vendor.

In a preferred embodiment, the dealership has the ability to link customers to prospect events, customers to campaign codes, campaign codes to ads, ads to advertising costs, and campaign codes to media/type/vendor data; and the media data represents the media in which an ad appears, the type data is a sub-class of media, and the vendor data reflects the media vendor.

In a preferred embodiment, the campaign development module comprises a campaign summary page; a media vendor is associated with each campaign, and wherein the campaign summary page identifies the media vendor; the campaign summary page identifies a media type, campaign code, vendor contact and dealership location for each campaign; the user can create a new campaign, edit an existing campaign, create a new ad, or delete a campaign from the campaign summary page; if the user elects to create a new campaign, a new campaign process is called; the new campaign process assists users in defining new campaigns; and the new campaign process comprises one or more pages that guide the user through the definition of a new campaign.

In a preferred embodiment, the ad development module comprises an ad list page; the ad list page lists all ads that have been approved; users can screen ads by start and end dates and/or ad status; and ad status is current, pending or expired. Preferably, the ad development module comprises an ad list page and an ad details page; the campaign development module comprises a campaign summary page; the ad details page is called when the user selects a specific ad on the ad list page or the campaign summary page; the ad details page comprises an ad details section, a dates and approvals section, a messaging section, and an inventory section; and the messaging section shows the initial new ad message from the dealership to the ad contact and all subsequent messages related to the initial new ad message.

In a preferred embodiment, the ad development module comprises a new ad page; the new ad page assists users in defining new ads to be included in a campaign; the user selects vehicles to be included in the new ad; the vehicles are selected by search, from a cart and/or from inventory; the user inputs start and end dates for the new ad; the user associates the ad with a campaign; the user enters an estimated cost for the ad; the user selects an ad contact; and each ad comprises contents and/or design, the user enters comments and/or instructions concerning the contents and/or design of the ad. Preferably, if the user elects to select vehicles from inventory, an inventory details page is called; the inventory details page comprises a cart section, a search section, a vehicle listing section, and a vehicle detail section; and the user can add vehicles to the cart from the inventory details page. Preferably, the inventory details page displays a base cost and a manufacturer's suggested retail price for each vehicle; the inventory details page allows a user to input markup, rebate and discount amounts; and a sales price for the vehicle is calculated.

In a preferred embodiment, the method further comprises providing a mini-desk calculation window that allows the user to calculate payment based on sales price, down payment and financing interest rate and term.

In a preferred embodiment, the vehicle detail section of the inventory details page comprises a valuation subsection and a profit center subsection; the valuation subsection displays vehicle valuation figures from third party sources; and the profit center subsection allows the user to calculate the potential profit associated with a particular transaction.

The present invention is also a method for developing and managing advertisement campaigns comprising: (a) providing an ad development module; (b) providing a campaign development module; (c) providing an inventory control module; (d) providing a messaging module; (e) providing a prospect event tracking module; and (f) providing a central data store; wherein each module accesses the central data store; wherein the central data store comprises data on products in inventory, existing customers, prospective buyers, advertisements and advertisement campaigns, contacts, communications, and marketing and/or sales materials from manufacturers; wherein the campaign development module allows users to create new ad campaigns; wherein the ad development module enables users to create new advertisements; wherein the inventory control module allows a user to search for products that meet certain criteria and to view data on selected products; wherein the messaging module manages communications within a sales entity, between the sales entity and customers, and between the sales entity and vendors; and wherein the prospect event tracking module links prospective buyers to interactions with the sales entity.

In a preferred embodiment, the central data store comprises an administration database, one or more sales entity databases, and one or more databases containing data that is common across sales entities; the sales entity databases contain data that is specific to a particular sales entity; the common databases comprise a media database and a third party application support database; and each sales entity implements its own sales entity database to ensure complete separation of all business data from other sales entities. Preferably, each ad is associated with a particular campaign; and each campaign is assigned a campaign code. The campaign code is used to link prospective buyers to the ads that introduced them to the sales entity. Preferably, each prospective buyer is assigned a customer identifier; and the campaign codes and prospect events are stored in the sales entity database and linked by the customer identifiers.

In a preferred embodiment, to create a new ad, the user selects a campaign, selects the products to be included in the ad, selects an ad contact, specifies a time period over which an ad is to be run, enters an estimated cost for the ad, enters comments and/or instructions regarding production of the ad, and saves the ad as a new ad. Preferably, once the new ad is saved, it is written to the sales entity database; when a new ad is saved, a new ad message is automatically generated and posted to a web messaging page; when a new ad is saved, an ad identifier and a new ad message identifier are automatically generated; and when a new ad is saved, an email is automatically sent to the ad contact with the address for the web messaging page on which the new ad message is posted.

In a preferred embodiment, a web messaging page is created for each new ad;

wherein the ad comprises contents and a design, and wherein the web messaging page allows the user and the ad contact to communicate with each other regarding the ad contents and design by posting messages to the web messaging page; the ad identifier and the new ad message identifier are used to generate the address for the web messaging page; and all messages concerning the ad are assigned identifiers related to the new ad message identifier and stored in the sales entity database. Preferably, the new ad message comprises a campaign code, the address for the web messaging page, an estimated cost of the new ad, and comments and/or instructions regarding the contents and/or design of the ad; and a file comprising a list of the products to be included in the ad is attached to the new ad message. The marketing and/or sales materials from manufacturers are preferably attached to the new ad message.

In a preferred embodiment, the ad contact reviews the new ad message, produces a proof of the ad, and posts a message with the proof attached to the message on the web messaging page; the user reviews and approves or declines the proof, and if the proof is declined, provides reasons for declining; an iterative process continues until the ad is approved; when the ad is approved, if the ad contact is a media vendor, then an email with the approved proof is sent to the ad contact; and when the ad is approved, if the ad contact is not a media vendor, then an approval notification is sent to the ad contact and an email with the approved proof is sent to a contact at the media vendor for publication or airing of the ad. Preferably, the method further comprises providing a new budget entry page, wherein when an ad is approved, an approval date is automatically assigned to the ad; wherein the estimated cost of the ad and the approval date are modifiable; wherein the user enters a total budgeted amount for advertising on the new budget entry page; wherein the cost of ads whose approval dates are within a sales entity's fiscal year are deducted from the total budgeted amount to generate a net amount; and wherein the net amount is reflected on a campaign summary page of the campaign development module.

In a preferred embodiment, a cost is associated with each campaign, and the cost of a campaign is calculated by querying the sales entity database for all ads associated with a particular campaign code. Preferably, the user has the ability to calculate the costs associated with one or more campaigns by media, media type and/or vendor.

In a preferred embodiment, a sales entity has the ability to link customers to prospect events, customers to campaign codes, campaign codes to ads, ads to advertising costs, and campaign codes to media/type/vendor data; and the media data represents the media in which an ad appears, the type data is a sub-class of media, and the vendor data reflects the media vendor.

In a preferred embodiment, the campaign development module comprises a campaign summary page; a media vendor is associated with each campaign, and wherein the campaign summary page identifies the media vendor; the campaign summary page identifies a media type, campaign code, vendor contact and sales entity location for each campaign; the user can create a new campaign, edit an existing campaign, create a new ad, or delete a campaign from the campaign summary page; if the user elects to create a new campaign, a new campaign process is called; the new campaign process assists users in defining new campaigns; and the new campaign process comprises one or more pages that guide the user through the definition of a new campaign.

In a preferred embodiment, the ad development module comprises an ad list page; the ad list page lists all ads that have been approved; users can screen ads by start and end dates and/or ad status; and ad status is current, pending or expired. Preferably, the ad development module comprises an ad list page and an ad details page; the campaign development module comprises a campaign summary page; the ad details page is called when the user selects a specific ad on the ad list page or the campaign summary page; the ad details page comprises an ad details section, a dates and approvals section, a messaging section, and an inventory section; and the messaging section shows the initial new ad message from the sales entity to the ad contact and all subsequent messages related to the initial new ad message.

In a preferred embodiment, the ad development module comprises a new ad page; the new ad page assists users in defining new ads to be included in a campaign; the user selects products to be included in the new ad; the products are selected by search, from a cart and/or from inventory; the user inputs start and end dates for the new ad; the user associates the ad with a campaign; the user enters an estimated cost for the ad; the user selects an ad contact; and each ad comprises contents and/or design, the user enters comments and/or instructions concerning the contents and/or design of the ad. Preferably, if the user elects to select products from inventory, an inventory details page is called; the inventory details page comprises a cart section, a search section, a product listing section, and a product detail section; and the user can add products to the cart from the inventory details page. Preferably, the inventory details page displays a base cost and a manufacturer's suggested retail price for each product; the inventory details page allows a user to input markup, rebate and discount amounts; and a sales price for the product is calculated.

In a preferred embodiment, the method further comprises providing a mini-desk calculation window that allows the user to calculate payment based on sales price, down payment and financing interest rate and term.

In a preferred embodiment, the product detail section comprises a valuation subsection and a profit center subsection; the valuation subsection displays product valuation figures from third party sources; and the profit center subsection allows the user to calculate the potential profit associated with a particular transaction.

### BRIEF DESCRIPTION OF THE DRAWINGS

FIG. 1 is a diagram of the application architecture of the present invention.

FIG. 2 is a diagram of the physical network architecture and data center of the present invention.

FIG. 3 is a diagram of the software architecture of the present invention.

FIG. 4 is a diagram of the current software implementation of the present invention.

FIG. 5 is a diagram of the central data store of the present invention.

FIG. 6 is a summary diagram of the campaign development and ad development processes.

FIG. 7 is a diagram of the campaign development process.

FIG. 8 is a diagram of the new ad definition portion of the ad development process.

FIG. 9 is a diagram of the save new ad portion of the ad development process.

FIG. 10 is a diagram of review and approve new ad portion of the ad development process.

FIG. 11 is a screenshot of a representative Campaign Summary page used to review existing campaigns in the Campaign Development module of the present invention.

FIG. 12 is a line drawing of a screenshot of the first page of the new campaign process.

FIG. 13 is a line drawing of a screenshot of the second page of the new campaign process.

FIG. 14 is a line drawing of a screenshot of the third page of the new campaign process.

FIG. 15 is a line drawing of a screenshot of the Input New Vendor page of the new campaign process.

FIG. 16 is a line drawing of a screenshot of the fourth page of the new campaign process.

FIG. 17 is a line drawing of a screenshot of the Input New Vendor Contact page of the new campaign process.

FIG. 18 is a screenshot of a representative Ad List page of the Ad Development module of the present invention.

FIG. 19 is a screenshot of a representative New Ad page of the Ad Development module of the present invention.

FIG. 20 is a screenshot of a representative New Ad page of the Ad Development module of the present invention as it appears after the user has identified a list of possible vehicles to be included in the new ad.

FIG. 21 is a screenshot of a representative Inventory Detail page called from the Inventory module by the present invention.

FIG. 22 is a screenshot of a representative Ad Details page in the Ad Development module of the present invention.

FIG. 23 is a screenshot of a representative New Budget Entry page in the Ad Development module of the present invention.

FIG. 24 is a diagram of the action flow for an ad campaign.

### REFERENCE NUMBERS

1 Campaign Development module
2 Ad Development module
3 Data store
4 Inventory Control module
5 Messaging module
6 Prospect Event Tracking module
7 Data center
8 Workstation
9 Internet
10 Web server
11 Database server
12 Firewall
13 Load balancer
14 Network switch
15 Client-side application
16 Server-side application
17 Two-way communication between server and data store
18 Two-way communication between client and server
19 HTTP Web Server
20 Application engine and libraries
21 Database (for storing application administrative data)
22 Database (for storing dealership data)
23 Database (for storing media data)
24 Database (for storing data to support third party applications)
25 Tables (for storing dealership administrative data)
26 Tables (for storing customer data)
27 Customers table
28 Prospect Events table
29 Inventory table
30 Tables (for storing third party data)
31 Contact table
32 Tables (for storing advertising data)
33 Campaigns table
34 Ads table
35 Special Ad Inventory table
36 Tables (for storing communications data)
37 Messages table
38 Step in the campaign and ad development process (where campaign is defined)
39 Step in the campaign and ad development process (where new ad is defined)
40 Step in the campaign and ad development process (where new ad is saved)
41 Step in the campaign and ad development process (where new ad is reviewed and approved)
42 Step in the campaign development process (where Location is determined)
43 Step in the campaign development process (where Media is specified)
44 Step in the campaign development process (where Type is specified)
45 Step in the campaign development process (where campaign code is input)
46 Step in the campaign development process (where New Vendor and New Vendor Contact are added)
47 Step in the campaign development process (where Vendor is selected)
48 Step in the campaign development process (where New Vendor Contact is added)
49 Step in the campaign development process (where Vendor Contact is selected)
50 Step in new ad definition portion of the ad development process (where Campaign is selected)
51 Step in new ad definition portion of the ad development process (where vehicles are selected)
52 Step in new ad definition portion of the ad development process (where new Ad Contact is added)
53 Step in new ad definition portion of the ad development process (where Ad Contact is selected)
54 Step in new ad definition portion of the ad development process (where Ad Contact user code and password are generated)
55 Step in new ad definition portion of the ad development process (where Ad Contact email is sent)
56 Step in new ad definition portion of the ad development process (where ad time period is input)
57 Step in new ad definition portion of the ad development process (where estimated cost is input)
58 Step in new ad definition portion of the ad development process (where comments and instructions are input)
59 Step in new ad definition portion of the ad development process (where ad is saved)
60 Step in the save new ad portion of the ad development process (where Ad Identification number is generated)
61 Step in the save new ad portion of the ad development process (where Ad Name is generated)
62 Step in the save new ad portion of the ad development process (where New Ad is written to database)
63 Step in the save new ad portion of the ad development process (where Message ID is generated)
64 Step in the save new ad portion of the ad development process (where URL is generated)
65 Step in the save new ad portion of the ad development process (where New Ad message is generated)
66 Step in the save new ad portion of the ad development process (where New Ad message is posted)
67 Step in the save new ad portion of the ad development process (where email is sent to Ad Contact)
68 Step in the review and approve new ad portion of the ad development process (where Ad Contact produces the ad)
69 Step in the review and approve new ad portion of the ad development process (where new ad proof is sent to user)
70 Step in the review and approve new ad portion of the ad development process (where user reviews ad proof)
71 Step in the review and approve new ad portion of the ad development process (where user approves or declines ad)
72 Step in the review and approve new ad portion of the ad development process (where Ad Contact revises ad)
73 Step in the review and approve new ad portion of the ad development process (where ad is sent to vendor)
74 Campaigns tab (on Marketing page)
75 Marketing tab (that displays Marketing page)
76 Buttons (for filtering campaign by Media)
77 Campaign specifications
78 Budget figure
79 Campaign code
80 Vendor
81 Media Type
82 Contact
83 Dealership business unit
84 User actions
85 New Campaign button
86 Drop-down menu (on first page of new campaign process where Media is selected)
87 Drop-down menu (where Type is selected)
88 Campaign Code input field (on second page of new campaign process)
89 Button (for exiting the new campaign process)
90 Button (for moving to next page)
91 Drop-down menu (on third page of new campaign process where Vendor is selected)
92 Menu choice (to add a new vendor)
93 Button (on Input New Vendor page of new campaign process for saving new vendor)
94 Drop-down menu (on fourth page of new campaign process where Vendor Contact is selected)
95 Menu choice (to add a new vendor contact)
96 Button (for moving to previous page)
97 Button (on New Vendor Contact page of new campaign process for saving new vendor contact)
98 Ads tab (on Marketing page)
99 Start date input field
100 End date input field
101 Check box (for showing approved ads)
102 Show Ads button
103 Ad specifications
104 Ad link
105 New Ad button
106 Start date input field on New Ad page
107 End date input field
108 Drop-down menu (where Campaign is selected)
109 Description input field
110 Help button
111 Select Vehicles section
112 Check boxes (for specifying method for selecting vehicles)
113 Select Vehicles section of New Ad page (after vehicles have been selected)
114 Vehicle specifications
115 Check box (to include vehicles in the ad)
116 VIN # link
117 Button (for saving new ad)
118 Inventory tab (that displays Inventory Manager page)
119 Cart section
120 Search section
121 Vehicle listing section
122 Vehicle detail section
123 Button (for adding vehicle to Cart)
124 Recall button
125 Menu button
126 Advanced Search tab
127 Quick Search tab
128 Specials tab
129 Search Button
130 Pricing subsection
131 Cost
132 Sale button
133 Calculation pop-up window
134 Valuation subsection
135 Tool tip pop-up window
136 Scroll bar
137 Profit center subsection
138 Ad Details section of the Ad Details page
139 Cost field
140 Dates and Approvals section
141 Messaging section
142 Inventory tab
143 Message
144 Attachments
145 Edit Ad button
146 Edit Approval button
147 Data entry section of New Budget Entry page
148 Budget entries section
149 Description field
150 Amount field
151 Drop-down menu (where location is specified)
152 Save Entry button
153 Delete button
154 Date range field
155 Total budget amount
156 Customer
157 Campaign
158 Prospect event
159 Status code

### DETAILED DESCRIPTION OF INVENTION

A. Overview

The present invention is a software application that increases efficiency and decreases costs associated with placing advertising campaigns by automating the manual processes associated with compiling the data for advertisements and integrating the paper-intensive, error-prone steps of the manual process into a smooth electronic interchange. The present invention facilitates the storage of data, the exchange of data between activities within the dealership, and the linking of data. Data on advertising expenditures can be linked to new prospect activity so that dealerships are able to track the efficiency of their advertising campaigns.

Automobile dealerships have attempted to automate their sales and marketing processes in the past. Most software solutions that attempt to automate these processes address only a single aspect of the business. While these solutions may be adequate for a part of the process, the difficulty and expense of managing multiple software applications from different vendors eliminates much of the efficiency gained from automation. The present invention delivers a series of integrated modules that automates all of the sales and marketing processes. The dealership benefits from the automation without the costs associated with lack of integration.

The efficiencies created by the present invention derive not only from the integration of the software modules but also from the integration of those modules around a central data store. The automobile dealership industry is extremely data-intensive. Reducing the data duplication that results from multiple software applications and making the data available to all steps in the process allow dealerships to manage their businesses using quality information. Other software applications, if they employ database technology at all, use proprietary databases accessible only by a single application. Data can only be linked by creating and maintaining multiple custom interfaces, and the resulting data is often out of date and inconsistent.

The current embodiment of the present invention is designed for use by vehicle dealerships, but it could be used by any business with significant and frequent advertising activity. It is especially appropriate for industries for which multiple items are included in each advertisement and where the ads must include large amounts of important data on each item.

The present invention is preferably a hosted application that dealers access over the web from workstations on their desktops. It is comprised of a central data store and modules that track, manage and advance prospects through the sales cycle, execute the tasks required to formulate a deal and book a car purchase, and manage communications within the dealership and between the dealership and its customers. These modules include, but are not limited to, Campaign Development, Ad Development, Inventory Control, Messaging, and Prospect Event Tracking modules.

Each module is linked to the others in a process flow that mirrors the way dealerships function. Embedded in each module and within the process is expertise about dealership operations. This solution is valuable not only for the dealership, but also for customers. Dealership productivity and efficiency are promoted by the integrated modules and the centralized data. Customers can select, customize, purchase and finance a car quickly and in the venue of their choice (online from their homes or in the dealership showroom).

Each module accesses a centralized data store that contains all of the information dealers require to run their business effectively. It includes data on vehicles in inventory, existing customers, prospective buyers, advertisements (including ads run and vendor and ad agency contact data), communications (internal, with customers, and with vendors), activities and tasks, and marketing and sales materials on cars from manufacturers (photos, video). The single unified data source supports all of the operational processes and ensures consistency. There is only one source for any piece of information, which eliminates data inconsistencies, conflicts and reconciliation problems.

The single data source also enhances efficiency. Instead of having to cobble together facts from myriad sources, disconnected systems and paper in a time-consuming manual process, data is accessed and delivered in an automated fashion to each module in every step in the process.

The central data store is updated from the back-end DMS (Dealer Management System) with manufacturer data for all of the vehicles in inventory. Events that affect the inventory, such as shipments, sales and special pricing, are reflected in the central data store when they occur, thereby reducing the need for manual input and unintegrated data downloads.

The Inventory Control module allows dealers to search for vehicles that meet certain criteria and select vehicles individually to be reviewed. Dealers can change the pricing components, and the changes are stored in the central data store and propagated throughout the system.

The Messaging module utilizes the connectivity of the web to speed communication internally within the dealership, between the dealership and customers, and between the dealership and vendors. The Messaging module is integrated into the central data store, and messaging activity can be triggered by events that are recorded in the central data store from other modules. For customers, this means better service through notification of recalls, recommended servicing, and arrival of cars of that meet their criteria. For the dealership, improved communications means improved efficiency because customer problems and opportunities will not be dropped and forgotten in the hand-off between different departments within the dealership.

The present invention delivers these capabilities without the dealer having to invest in significant hardware to run the system, security to protect customer information, or the technical personnel required for maintenance. The solution is preferably delivered via a web-based application server, and the centralized web and data servers are preferably protected by multiple layers of security. Multiple redundant servers provide data backup and load sharing. The dealer accesses and runs the system over the web from the browser on its workstations.

The Campaign and Ad Development modules leverage data access and integration with the Inventory Control and Messaging modules to streamline the creation of ads and ad campaigns. It enables dealers to build and publish an ad more quickly and efficiently with the assurance that the information published is accurate, current and consistent across ads.

One area of increased efficiency is that the time required to compile the necessary components for an ad and deliver them to the agency is significantly reduced. This time savings comes from automation and the process intelligence designed into the modules.

A critical component of the ad package is the listing of cars to be included in the ad. Within the inventory module, the dealer can select cars to be included, either individually or based on dealer-defined selection criteria. All of the necessary data on each vehicle is automatically delivered from the database to the screen for review and to an electronic file to be sent to the ad agency. This automated selection and data collection process replaces the time-consuming, error-prone manual compilation activities. Because all ads and showroom sales access the same inventory data, inconsistencies in pricing between different ads and between ads and the showroom are eliminated, as is the customer aggravation and potential lawsuits that such inconsistencies provoke.

The Ad Development module “knows” what components are required for a complete ad, and most of those components are accessible directly from the central data store database: data on existing ad campaigns, inventory associated with the ad, vendors, ad agencies and contacts. Manual input is reduced, the necessary components are automatically compiled, and the delays caused by incomplete submissions are eliminated. A single ad can be compiled in minutes.

Once the ad is submitted to the agency, the time between submission and publication is also reduced. All communication—submission, review, iterations and approvals—can be done electronically, thereby eliminating the complications of scheduling meetings and phone calls. The Messaging module sends alerts to notify the agency and the dealership that action is required, and the history of the communications about the ad development is maintained. The automatic notification of next steps means that things are less likely to be overlooked or forgotten. Automated scheduling alerts notify dealers when ads are due to expire, making it easier for dealers to manage their campaigns and ensure consistent exposure.

The invention not only allows dealers to cut costs, but it also gives them the information and tools to enhance profit. The Inventory Control module incorporates tools to determine pricing based on the differing levels of profitability so that when a dealer advertises discounts and special pricing, it can be done with the potential profitability in mind.

In a preferred embodiment, dealer actions and expenditures are linked to customer events and sales. This provides dealers with the means to evaluate the effectiveness of ad campaigns across different media for bringing prospects in the door and converting them to car buyers. In the preferred embodiment, for each prospective customer, there is a link to the advertisement or advertisements that brought that customer into the dealership, together with information on the costs of those advertisements. Dealers can calculate the total costs of advertising in different media, with different vendors, and determine whether they are getting sales results that justify the expenditures or whether they can enhance profit by shifting advertising strategies.

B. System Architecture

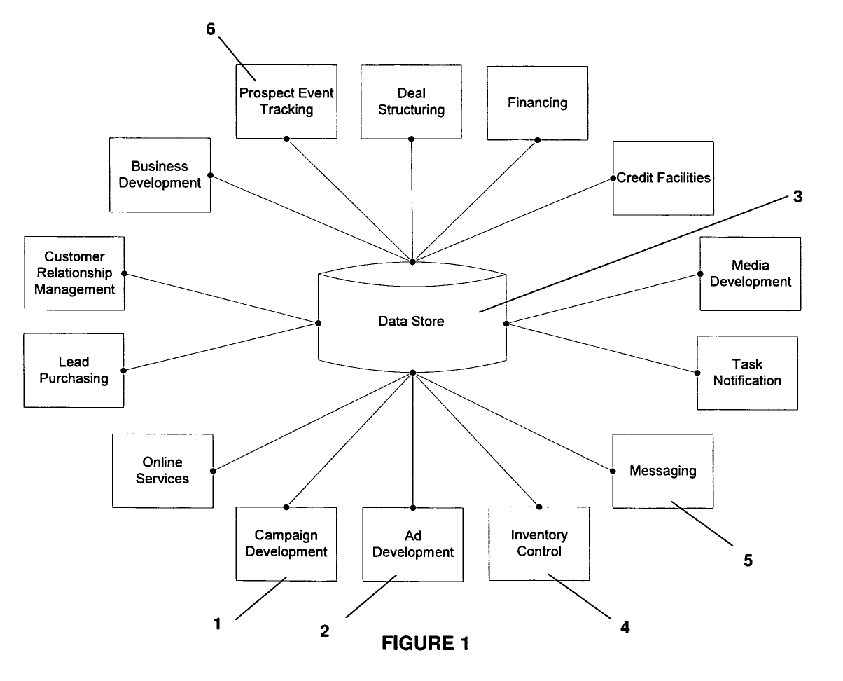

FIG. 1 is a diagram of the modules that comprise the present invention. In the current embodiment of the present invention, the Campaign Development 1 and Ad Development 2 modules are included as part of a suite of front-end solutions for vehicle dealerships. These front-end solutions support all of the sales and marketing processes within a dealership, including but not limited to, advertising, lead development, tracking of prospects through the sales cycle, deal structuring, financing and inventory control. These modules are linked by a central data store 3 that centralizes the critical data used within the dealership. This integrated suite of software applications enables the smooth integration of the dealership's operational processes.

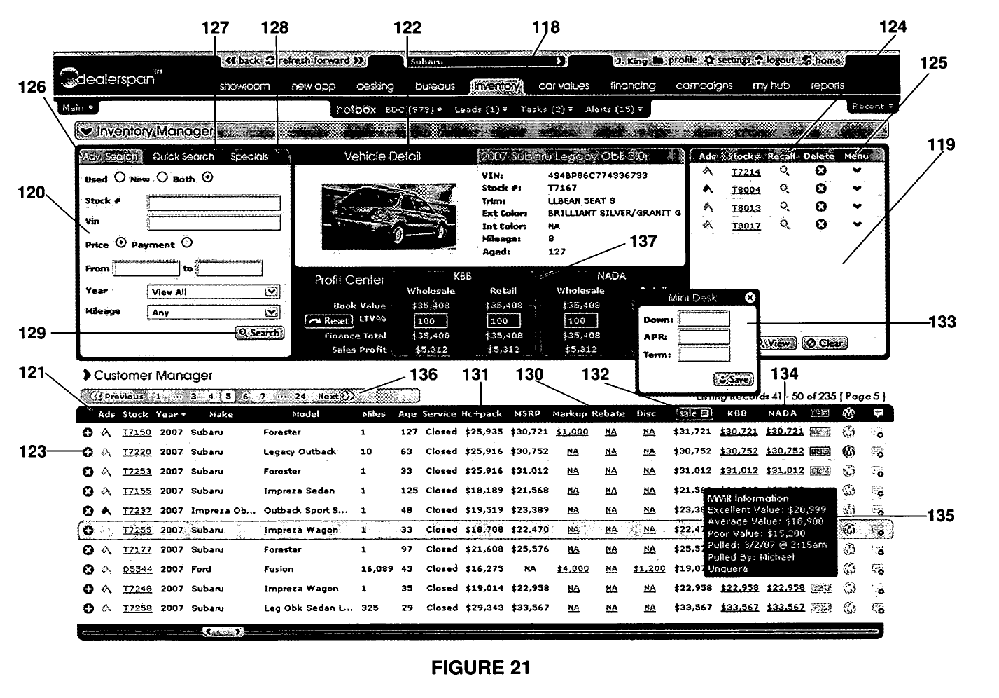

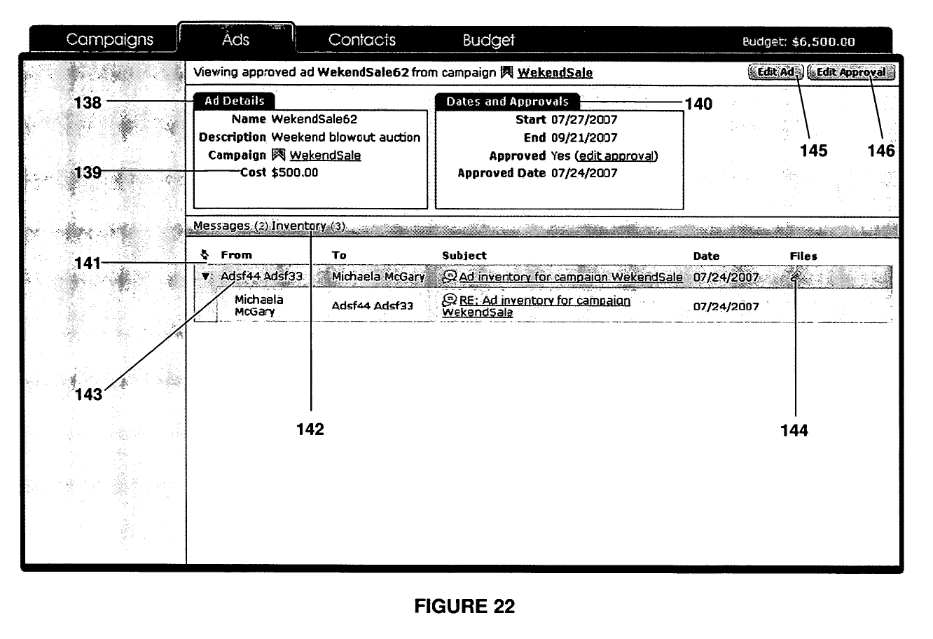

In the current embodiment, the Campaign Development 1 and Ad Development 2 modules use data provided by the Inventory Control 4, Messaging 5 and Prospect Event Tracking 6 modules. Several pages from these modules are called by the Ad Development module 2 when defining a new advertisement. Examples of these pages are shown in FIGS. 21 and 22.

Although the current embodiment focuses on vehicle dealerships, the campaign and ad development modules could be used by any business with significant and frequent advertising activity where there are many disparate data elements that comprise each ad. This includes, but is not limited to, businesses where the advertising includes multiple products and large amounts of critical data on each product, for example, real estate sales and rentals.

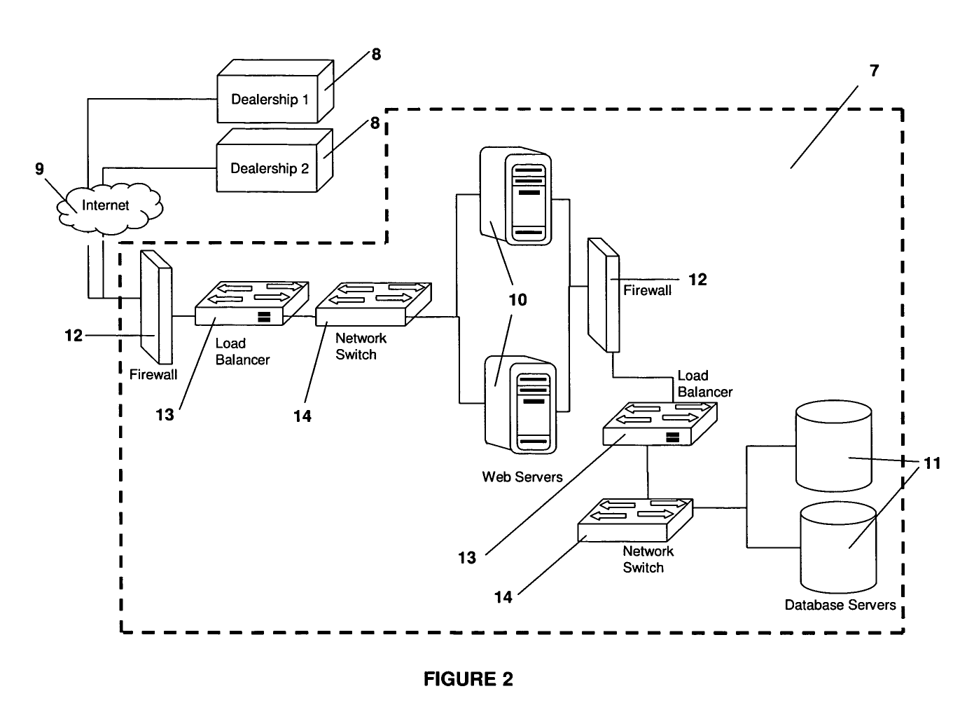

FIG. 2 is a diagram of the physical network architecture of a preferred embodiment of the present invention. This diagram shows the data center of the present invention 7, and various dealership workstations 8 that communicate with the data center. In a preferred embodiment, the software modules that comprise the present invention are hosted applications, that is, they reside on servers 10 at a centralized data center rather than on the workstation at the dealership. The dealership workstations 8 communicate with the present invention over the web 9. The multiple redundant web servers 10 host the application, supported by multiple redundant database servers 11. Requests come from the dealership workstations 8 over the web 9 and pass through the firewall 12 between the external environment and the data center. The load balancer 13 and network switch 14 route the request to a web server 10. Database queries are invoked by the application on the web server and pass through a second firewall 12. They are then routed to a database server by the load balancer 13 and network switch 14. The database servers 11 are secured behind two firewalls 12 to ensure the security of customer data. In this configuration, they are only accessible by the web servers and cannot be accessed from outside the data center.

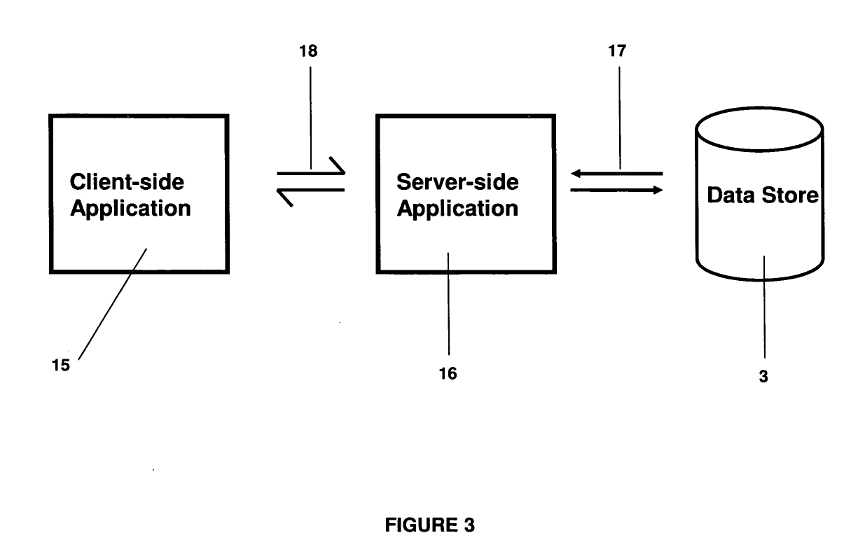

FIG. 3 is a diagram of the software architecture of a preferred embodiment of the present invention. User actions on the client-side application 15 send requests for web pages to the server-side application 16. An XML (eXtensible Markup Language) file describing the layout of the page is returned to the client and interpreted by the browser 18. Embedded in the XML file are calls to PHP (PHP Hypertext Processor) scripts, which execute on the server. PHP scripts, with parameters passed from the client, drive interaction with the databases that comprise the data store 3, perform calculations and return results to the web page. Database queries are performed by SQL (Sequential Query Language) 17. JavaScript is the client-side scripting language that executes on the client with parameters passed from the server.

In the preferred embodiment of the present invention, XHR (XMLHttpRequest) is an application programming interface (API) used to increase the interactivity and speed of the application. XHR allows the client side to issue function calls to the server, exchanging small amounts of data with the server behind the scenes, without refreshing the whole page. This allows portions of the screen to be updated without reloading the entire page. Data is passed using XML (eXtensible Markup Language) and JSON (JavaScript Over Network) formats.

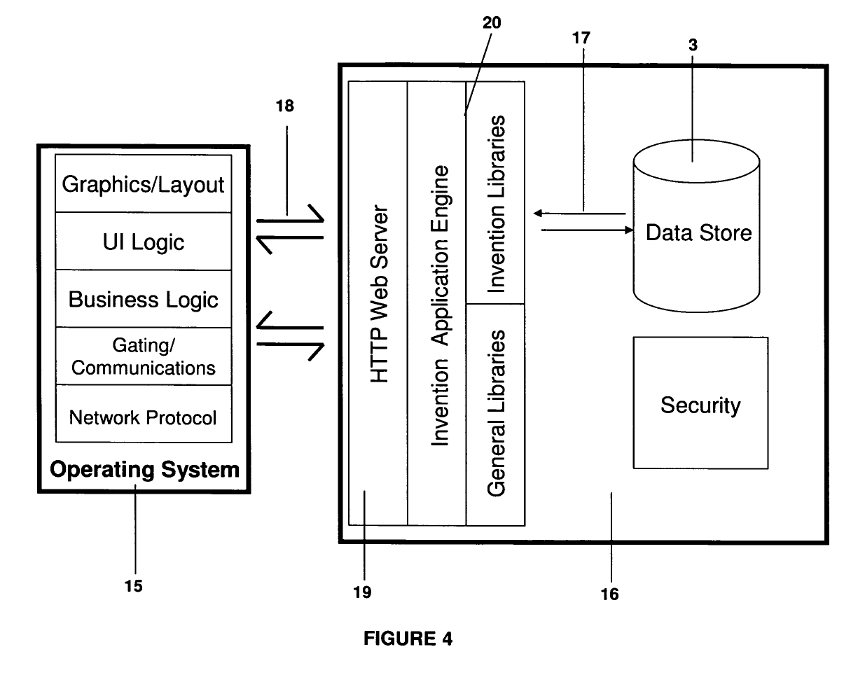

FIG. 4 is a diagram of the current software implementation of the present invention. In the current embodiment, the client side user interface 15 runs in a custom client browser that is implemented using the Mozilla project. The present invention can run in any operating system; this operating system-independence is enabled by Mozilla. The hosted application on the server side 16 preferably runs on a Linux-based operating system. In a preferred embodiment, the communication between the browser and the web server 18 uses XML (eXtensible Markup Language) over HTTP (HyperText Transfer Protocol) and JSON (JavaScript Object Notation), and the HTTP Web Server is implemented in Apache 19. Data is written to and retrieved from the database using SQL 17, and the data store 3 is implemented in MYSQL. The application engine and libraries are written in PHP (PHP: Hypertext Preprocessor) 20.

Alternately, the client side application 15 could be implemented in any web browser that supports HTTPS, W3C Standard xHTML 1.0 and ECMA standard JavaScript. The data store 3 could be any relational database management system that supports transactional operations. The server application 16 could be implemented in any application platform that can issue queries to a relational database and submit data to a browser. Such tools include, but are not limited to, ASP .NET, JSP (Java Server Pages), and PSP (Python Server Pages). Communication between the server application and the data store 17 could be in any query language compatible with the relational database. This will typically be ANSI SQL, but alternatives include variants on SQL.

For communication between the server application and the client side application 18, alternate implementations include any tool that can accept HTTP requests from client web browsers and serve them HTTP responses along with optional data contents, including any World Wide Web Consortium (W3C)-compliant implementation of an HTTP server. Examples include, but are not limited to, AOLserver, Apache, Apache Tomcat, Obelisk-HTTP, nhttpd, IIS and Oracle HTTP Server. The server operating system will typically be a Unix variant such as Linux Distribution or SunOS, but it could be any operating system that is supported by the web server and server application platform. These can include any server variant of the Microsoft Windows operating system.

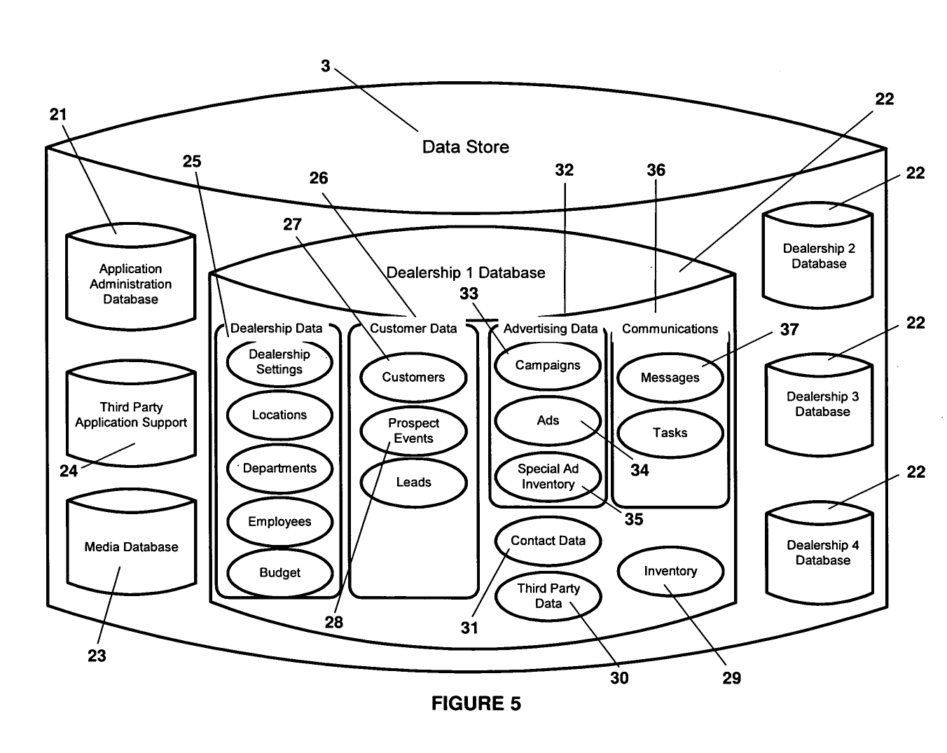

FIG. 5 is a diagram of the data store of one embodiment of the present invention. In a preferred embodiment, the data store is composed of an Application Administration Database 21, other databases containing data that are common across dealerships, and multiple dealership databases 22. The Application Administration Database 21 contains files that support the functioning of the modules, such as help files and user login data. The common databases include, but are not limited to, a Media Database 23, which contains photographs and video from third-party providers of vehicle media as well as vehicle photographs and video created by the dealerships, and databases that support other applications that interact with the present invention 24. These latter databases include, but are not limited to, databases supporting online auction websites and financing applications. The dealership databases 22 contain all of the data specific to a particular dealership. Each dealership using the present invention implements its own dealership database to ensure complete separation of all business data from other dealerships using the present invention.

In the current embodiment of the present invention, the dealership database 22 contains six major types of data. The dealership data tables 25 contain data that describes the dealership, including, but not limited to, data that customizes the application for a specific dealership and organization information such as physical locations, departments and employees. The customer data tables 26 contain data on existing customers 27 and prospects 28, including contact information, source, and activity history. Inventory data tables 29 contain data on vehicles in inventory. The dealership and inventory data tables are populated by feeds from the back-end DMS (Dealer Management System). Other tables are populated as the modules are used. For example, customer data is loaded as customers make contact with the dealership and their information is gathered and input by dealership personnel.

Data on organizations with which the dealership does business, such as media vendors, ad agencies and companies providing financing, is stored in the third party data tables 30. These third party data tables include tables containing data on each organization, such as name, address, phone numbers, website and type of company (ad agency, media vendor, etc.). Associated with these third party tables are the contact data tables 31, which contain contact data for people at outside organizations as well as contact data for people within the dealership. The contact data tables are updated using an administrative screen.

Within the set of advertising data tables 32, the Campaigns table 33 stores data on all campaigns, and the Ads table 34 stores data on all ads. A Special Ad Inventory table 35 stores the list of vehicles that are included in each advertisement. New lists of vehicles are added to this table whenever the user saves a new ad definition.

The communications tables 36 store auto-generated reminders and include the Messages table 37, which stores message histories of communications within the dealership and between the dealership and third parties, as well as files attached to the messages.

C. Campaign and Advertisement Development Process

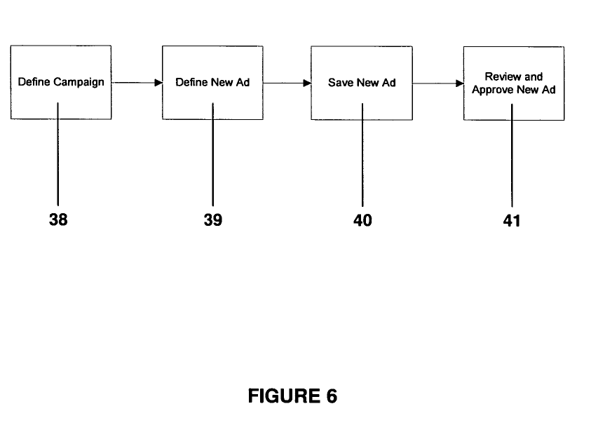

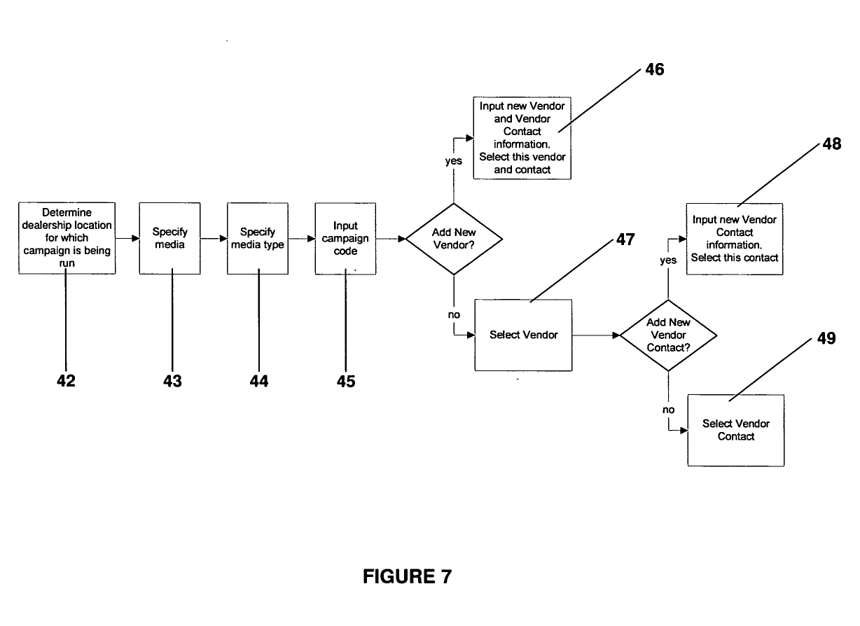

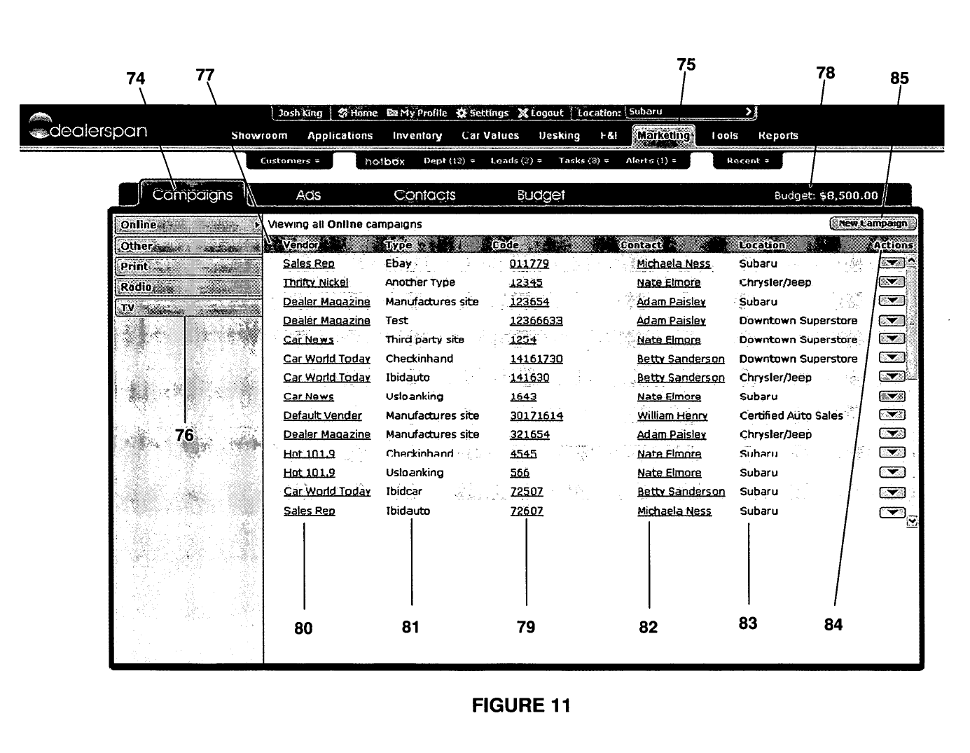

FIGS. 6, 7, 8, 9 and 10 illustrate the campaign and ad development processes, as implemented in the present invention. FIG. 6 is a diagram of the four main steps in the campaign and ad development processes. The steps are: define the campaign 38, define a new ad 39, save the new ad 40, review and approve the new ad 41. FIGS. 7, 8, 9 and 10 show the detail involved in these four main steps. The screenshots in which this functionality is implemented in the present invention are shown in FIGS. 11 to 22.

In advertising industry practice, “running a campaign” generally means running multiple ads under the umbrella of a single campaign. Consistent with this practice, an advertising campaign in the present invention consists of multiple advertisements, and each advertisement can only be associated with a single campaign. Within the present invention each campaign is associated with a specific location within the dealership and a specific media vendor. Each ad within a campaign is defined by the period over which it is run and the vehicles included. The ad is also associated with the specific advertising agency that produces the ad. The cost of advertising is tracked at the ad level. Costs include both the cost of creating the ad and the cost of running it.

Note that in the present invention all of these steps are carried out electronically, and the results of each step are captured in various tables in the dealership database 22. The precise pages and tables of the present invention on which these actions appear and are recorded are discussed below.

FIG. 7 shows the detailed steps of the campaign development process within the context of the present invention. In the first step of the campaign development process, the dealership location for which the ad is being run is determined 42. Dealerships can be structured as multiple physical locations linked by an umbrella organization. Each location is responsible for running its own campaigns and advertisements. Within the present invention, the location is determined by the location of the workstation from which the user logs on. The user can change this setting once he has logged onto the system.

In the second step of the campaign development process, the user selects the Media in which the ads associated with the campaign will be run 43. The list of possible media is set by the present invention and includes Online, Print, Radio, TV and Other. Note that if Print is selected, then when a new ad is saved (see below), the information that is provided in the ad will also be automatically uploaded to third party auction sites, if applicable, and the dealership website, for the vehicle or vehicles covered in the ad.

In the third step of the campaign development process, the user selects the Type 44. The Type attribute is a sub-classification of Media, which allows users to further characterize Media. For example, if Media is Print, the subtypes might include Content, indicating that the ad would appear on a page with content, Classified, indicating that the ad would appear in the classified section, or Pullout indicating that the ad would appear in a separate pull-out section. The values for Type are determined by each dealership.

In the fourth step of the campaign development process, the user inputs a campaign code 45. The campaign code uniquely identifies each campaign. The campaign code links prospects to the advertising that introduced them to the dealership, and it is by this code that dealerships can evaluate the effectiveness of advertising. Prospective buyers are asked for the campaign code when they call or visit the dealership or enter the website on which the vehicles are advertised.

The first time prospective buyers contact the dealership, they are asked for their name, address, phone number and email address. These fields together constitute the customer identifier for each customer. Each subsequent time a prospect interacts with the dealership, an electronic record of the interaction is generated. The generation of the record is either automatic if the interaction is electronic (for example, through the website) or manual if created by the sales person. The records of these interactions are called prospect events. All of this data—the customer identifiers, the campaign code and the prospect events—is stored in the dealership database, linked by the customer identifiers. Using these linkages, dealerships can track the results of advertising campaigns based on the actions of the prospects introduced by the campaigns.

In the fifth step of the campaign development process, the user selects the Campaign Vendor. The Campaign Vendor is the specific media outlet in which the ads associated with the campaign will appear. For example, if the Media is Radio, the Campaign Vendor would be the specific radio station on which the ads will air. The user can add a new vendor 46 at this stage or select a vendor that has already been defined to the invention 47.

In the sixth and last step of the campaign development process, the user identifies the Vendor Contact. This is the person who works for the vendor to whom the completed, approved ads are sent for publication or airing. As with the vendor, the user can add a new vendor contact 48 or select a vendor that has already been defined to the invention 49.

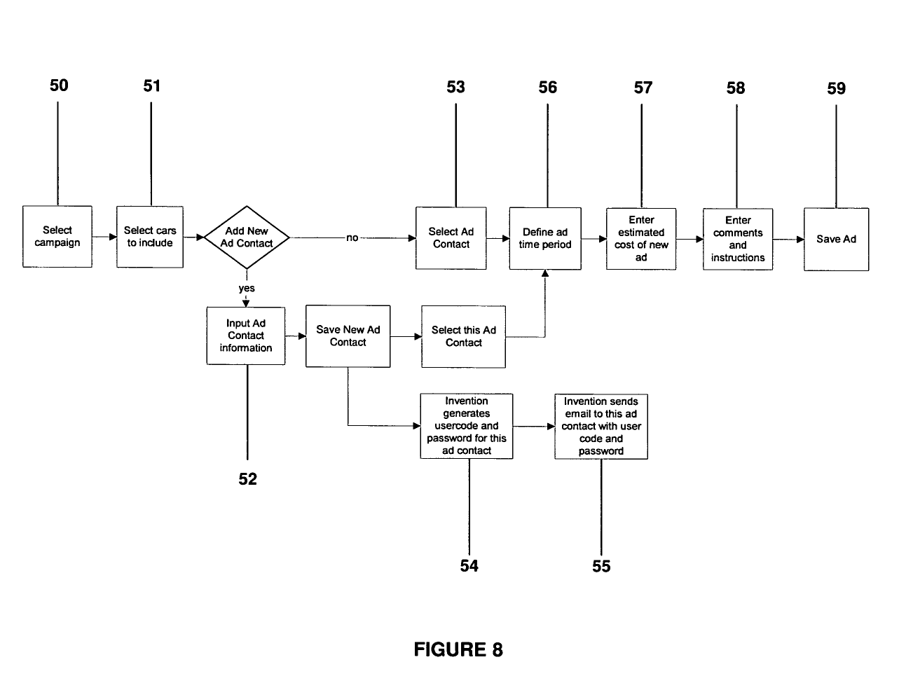

FIG. 8 shows the new ad definition portion of the ad development process of the present invention. In this process, the user of the present invention is the person at the dealership who is responsible for the definition of the new ad. The person at the ad agency or the vendor who is responsible for producing the ad is called the Ad Contact.

In the first step of the ad development process, the user selects the campaign under which the ad is run 50.

In the second step of the ad development process, the user selects the vehicles to be included in the ad 51. This list of vehicles is also referred to as the inventory list.

In the third step of the ad development process, the user selects the Ad Contact. The Ad Contact is the person to whom the information comprising the ad is sent. This may be someone at the advertising agency (if the ad needs to be designed and produced) or someone at the vendor (if there is already a template for the ad and only the specific information pertaining to the ad in question is changing). At this stage, users can add new contact 52 or select a contact that has already been defined to the invention 53. When a new contact is added, the invention registers the contact by assigning a user code and password 54 with which the contact can access the invention. The new contact is notified that it is a registered user via email 55. The email includes the user code and password.

In the fourth step of the ad development process, the user specifies the time period over which the ad is to be run by inputting the start and end dates 56.

In the fifth step of the ad development process, the user enters an estimated cost for the ad 57. This cost is the total of all of the cost elements that go into producing and running this particular ad. As the actual costs of the ad become known, this cost figure can be modified using the Ad Details page (described below, FIG. 22, 139).

Finally, the user enters any comments or instructions regarding the production of the ad 58.

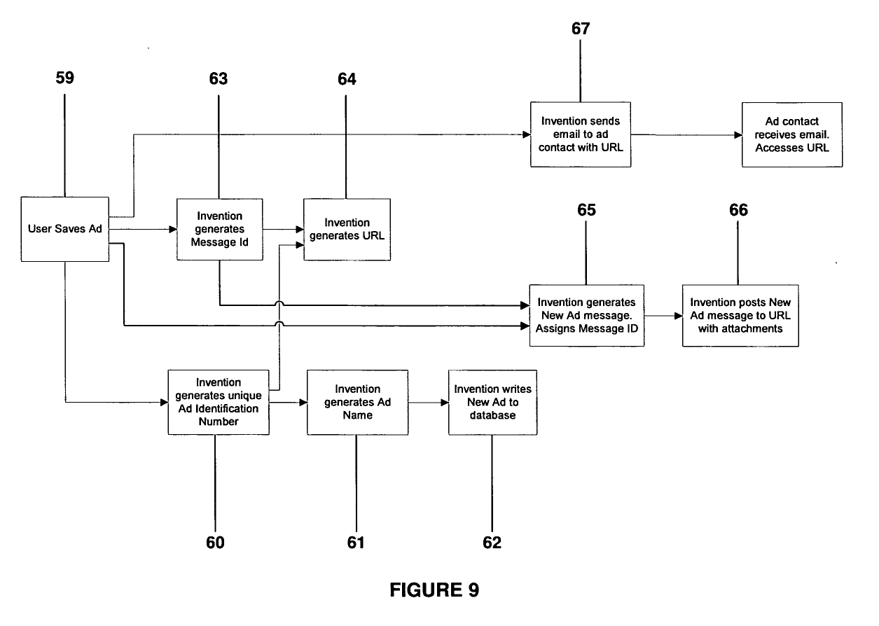

After the elements of the ad have been defined, the user saves the new ad 59. This initiates the process shown in FIG. 9.

FIG. 9 is a diagram of the save new ad portion of the ad development process, which shows the steps from the time the user saves the ad until the initial New Ad message is posted on the Messaging website. The Messaging website (explained in greater detail below) is the site over which all of the communication about the new ad occurs.

There are two types of activities that are initiated when the user saves the new ad. The first involves writing the new ad to the dealership database 22. In addition to the information input by the user, the invention generates a unique identifier for the new ad 60 and then uses the identifier to create a name for the new ad 61. The invention also sets the status of the new ad to “Pending.” All of these elements of the new ad are written to the dealership database 62.

In the second activity, the invention initiates communication with the Ad Contact. Communication within the present invention occurs in two ways: directly via email and over the web-based messaging system implemented in the Messaging module 5. In the first instance, certain events will cause the invention to retrieve an email address from the Contact table 31 in the dealership database 22, generate an email and send it to the selected address. The recipient retrieves the email via an email application. An example of this is noted above when registering a new contact 55. In the second instance, the present invention uses a custom web-based messaging system. With the web-based messaging system, no emails are exchanged. Instead, message text is entered into a web page, and the message is saved in a database. The recipient retrieves the message by going to a specific web address and logging onto the messaging system. (It is this log-on process that necessitates assigning the Ad Contact a user code and password). The messaging system identifies the user and then queries the database for messages posted to this recipient. Messages are retrieved and displayed on the page.

When a new ad is being created, the exchange of information about the ad contents and design between the user and the Ad Contact (who is responsible for producing the ad) occurs electronically. The means by which this electronic communication occurs is a web messaging page that is specifically created by the present invention for each new ad. In a preferred embodiment, the web messaging page has two panels. The top panel of the page displays a listing of message to the recipient, which in the case of the ad development process is either the user or the Ad Contact. Highlighting a message displays the body of the message in the bottom panel. Messages between the Ad Contact and the user pertaining to the new ad are posted to this page, along with attachments. These messaging web pages are part of the Messaging module 5 of the present invention.

When a new ad definition is saved, the invention generates a unique message ID 63 to be assigned to the New Ad message to the Ad Contact. A unique Ad ID is also generated 60. The message ID and the Ad ID are used to generate the URL (Uniform Resource Locator) for the messaging website for this new ad 64. The invention then generates 65 and posts 66 the New Ad message to the website. This message contains all of the information that the Ad Contact requires to produce the new ad. The message is the electronic equivalent of the step in the manual ad development process in which the user at the dealership physically compiles all of the elements of a new ad and delivers them to the Ad Contact.

In a preferred embodiment, the New Ad message contains five items: the campaign code (entered in FIG. 7, 45), the toll-free number for the dealership hotline, the URL for the web page to which prospective buyers can go to view the advertised vehicles, an estimated cost of the new ad (entered in FIG. 8, 57), and the instructions the user wishes to convey about the design of the ad (entered in FIG. 8, 58). The toll-free number and the new ad URL provide prospective customers with two ways to contact the dealership without physically visiting the dealership. Attached to the message are photos of the included vehicles and a file containing the list of vehicles included in the ad.

The campaign code is the unique code that the user assigned to the campaign with which the new ad is associated. It is the code that links the campaigns to the prospective buyers.

A toll-free phone number is published with all ads to capture prospect phone calls. Preferably, there is a single phone number for the entire invention. If prospective customers telephone about an advertised vehicle, as opposed to physically visiting the dealership or visiting the campaign website, they call the toll-free number published with the ad. A third party service answers the calls and gathers information from the prospect. This information is transcribed and digitized, and the data (including name, address, phone number, email and campaign code) is sent in electronic format to the centralized data center 7. The electronic file is loaded into the present invention, and, using the campaign code as the identifier, the dealership that is running the ad is identified. The customer data is then stored in the Customers table 27 of the correct dealership database 22, and this information constitutes the unique identifier for each customer. The customer identifier is saved with the campaign code, allowing the dealership to link campaigns with prospects who phone in.

The new ad URL is the address of a page on the dealership's website that pertains to the new ad. Prospective customers access this page to make contact with the dealership and view the vehicles included in the new ad. When prospective customers access this web page, they are asked to provide their contact information (name, address, phone number, email address) and the campaign code attached to the advertisement that referred them to the website. The dealership web page is integrated with the present invention so that the contact information and campaign code can be saved to the Customers table 27 of the dealership database 22, providing a link between campaigns and the prospects who respond to an ad via the web.

Photos of the vehicles included in the ad, as well as other media such as 360° views (called “spins”) and video, are sent as attachments to the New Ad message. The list of vehicles included in the ad, together with data on each vehicle (such as Year, Make and Model), is written to a CSV (Comma Separated Values) file by the invention and attached to the email.

This original message to the Ad Contact is the start of a thread of messages between the Ad Contact and the user concerning the new ad being developed. The original message is assigned a unique Message ID 63. All of the messages in the thread are assigned IDs related to this message ID, and all messages are stored in the dealership database 22.

The other communication with the Ad Contact is an email, sent directly to the Ad Contact's email address, that provides the Ad Contact with the URL (Uniform Resource Locator) of the messaging website 67.

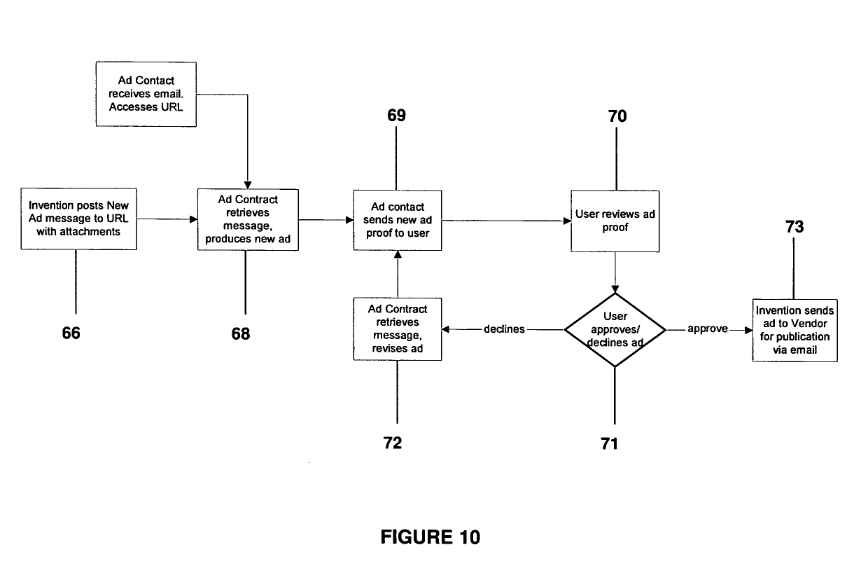

FIG. 10 is a diagram of the review and approve new ad portion of the ad development process. This figure shows the detailed process that begins when the New Ad message is posted on the Messaging website and ends when the new ad is approved by the user at the dealership. In the first step of this process, the Ad Contact retrieves the new ad message and produces a proof of the ad 68. The Ad Contact then posts a message with the proof of the ad back on the Messaging website for the user 69. This is done by replying to the original message and attaching the proof. The user reviews the proof 70 and can approve or decline the proof 71 by replying to the message. If the user declines the ad, the reasons for declining the ad are included in the message and used by the Ad Contact to revise the ad 72. This iterative process continues until the ad is approved. When the ad is approved, the present invention sends an approval notification to the Ad Contact and sends an email with the approved proof to the Vendor Contact for publication or airing 73. The status of the new ad in the Ads table 34 is set to “Approved.” At this point the invention presents the user with the opportunity of modifying the cost of the ad. If the user changes the cost, the new cost is updated in the Ads table.

D. Campaign and Advertisement Development System

The sections below describe how the campaign development and ad development processes are implemented within the present invention. Screenshots and drawings of pages of the invention are presented, along with a detailed discussion of how the process is reflected in the flow of screens and how data is retrieved from and written to the data store.

In the current embodiment of the present invention, the user accesses the desired page by clicking on the appropriate tab. The tabs are laid out in two hierarchical layers. The tabs in the top layer represent the primary sales and marketing functions, including, but limited to, Inventory Control, Deal Structuring (known as “desking” in the industry) and Marketing. These tabs are visible on any page in the application. When the user clicks on a tab in the top layer, he is presented with a page on which another layer of tabs is displayed. These tabs represent activities within the main functions. For example, clicking on the Marketing tab brings up a page which displays tabs for Campaigns, Ads, Contacts and Budget, all activities within the Marketing function.

FIG. 11 is a screenshot of a representative Campaign Summary page of the Campaign Development module of the present invention. When the Campaigns tab 74 on the Marketing page 75 is clicked, the custom client browser sends a request for the Campaign Summary page to the server, along with the relevant parameters. These parameters include (i) the dealership location that is running the campaigns and (ii) a media. The server returns the HTML for the Campaign Summary page, which is rendered by the browser. The request launches an SQL query against the Campaigns table 33 within the dealership database 22 for all campaigns meeting the criteria set by the parameters. The dealership location is set by the user during log on.

In the initial call, the default parameter sets the filter to Media Type=Online so that only data for Online campaigns is displayed. The buttons on the left panel 76 allow users to change the filter. Clicking on a button sends a request to the server to retrieve campaigns where the Media is equal to whichever button was clicked. HTML is sent back, and the new information is brought into JavaScript, which renders the new information on the page.

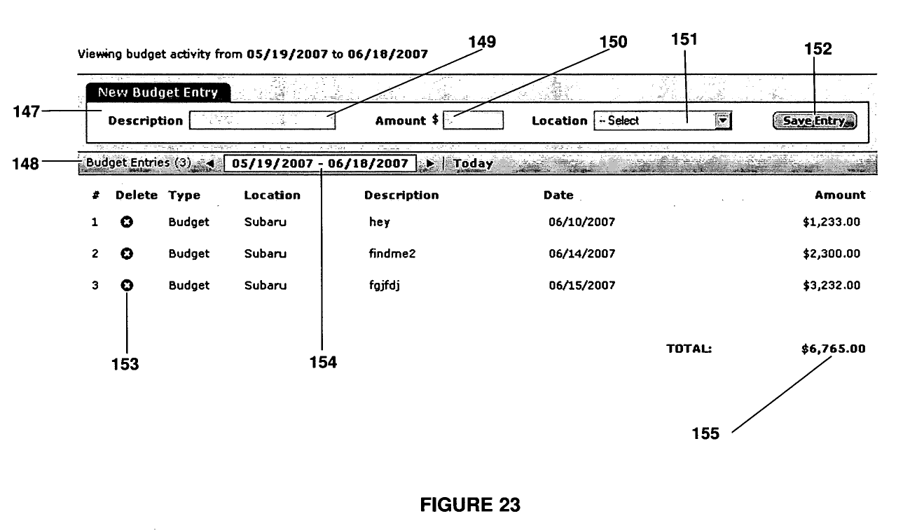

The SQL query launched by the request returns the rows from the Campaigns table 33 that met the criteria set by the parameters. Attributes returned 77 include Vendor, Type, Code, Contact and Location. The Budget FIG. 78 is the unspent amount remaining in the advertising budget for the fiscal year. The way in which this budget amount is calculated is described below (FIG. 23).

The campaign code 79 uniquely identifies each campaign.

The vendor column 80 on the Campaign Summary page identifies the media vendor associated with the campaign. These individual vendor names are links to data rather than simply text displayed on the page. Clicking on a vendor's name sends a query to the Vendor table (within the third party tables 30) in the dealership database 22 and returns a page displaying general vendor contact information, including, but not limited to, address, phone numbers and employees within the vendor organization who are designated as contacts for the dealership.

The Type column 81 displays the Media sub-classification.

The Contact column 82 displays the name of the vendor contact chosen for the particular campaign. Like the Vendor column, the contact column displays links to the data. Clicking on the contact name sends a query to the Contact table 31 in the dealership database 22 and returns a page displaying the contact information of the particular person within the vendor organization, including but not limited to phone numbers and email addresses.

The Location column 83 displays the particular location within the dealership corporate structure that is managing the campaign. The location can refer to the umbrella dealership organization or to an individual location within the dealership organization.

In the Action column 84 a drop-down button is displayed next to each campaign in the list. When the drop-down button is clicked, a menu offers the user three options: Edit Campaign, Create a New Ad or Delete Campaign. The action is executed for the campaign shown in the row next to the drop-down button that was clicked.

If the user selects Edit Campaign, the application executes a query against the Campaigns table 33 and selects the table row where the campaign code of the campaign selected on the page is equal to the campaign code in the table. The application calls a page that displays the editable fields, which, in the current embodiment, include the campaign code and vendor contact. The user can change either of these fields. When the <Save> button is clicked, the application updates the appropriate row in the Campaigns table 33.

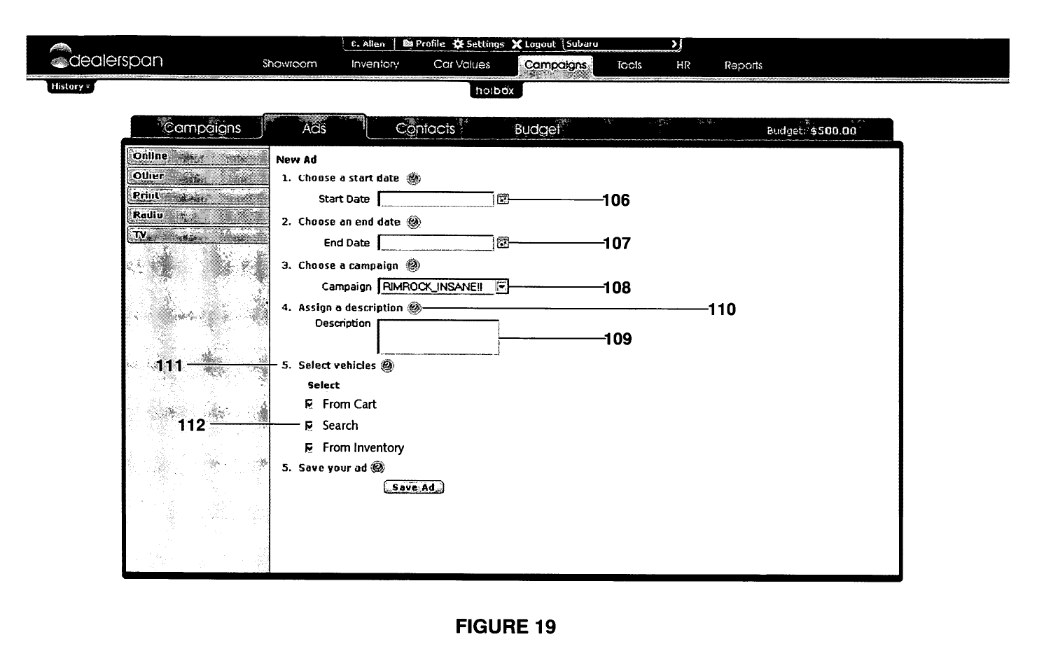

If the user selects New Ad, the application calls the New Ad page (see FIG. 19).

When the user selects Delete Campaign, the application flags the appropriate row in the Campaigns table 33, as well as the rows in the Ads table 34 for the ads associated with the deleted campaign. No data is deleted from the tables, but the flags indicate that queries to the campaigns and ads tables should not return the flagged rows.

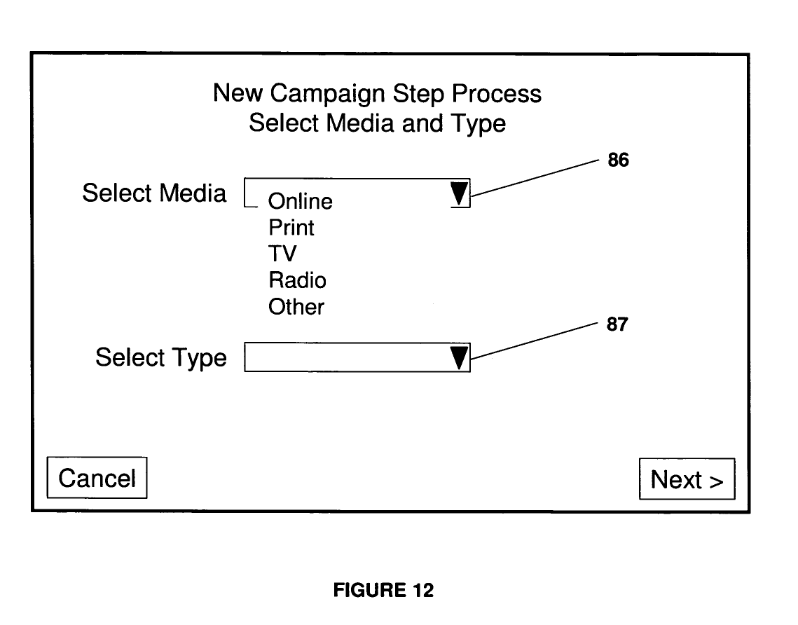

The New Campaign 85 button calls the new campaign process. The new campaign process is a series of pages (FIGS. 12-17) that guide the user through the definition of a new campaign.

FIG. 12 is a line drawing of a screenshot of the first page of the new campaign process of the present invention. On this first page of the process, the user is prompted to select the media in which the ad is to be presented 86. The field is a drop-down menu populated with the values for the Media attribute. In the current embodiment, the values for Media are specified at installation as Online, Print, Radio, TV and Other. These values are stored in a metadata table in the dealership database 22. The metadata tables in the various databases in the data store 3 contain pre-defined values that populate the various drop-down menus throughout the invention. The Media metadata table in the dealership database is queried and the returned values populate the Media selection drop-down 86. The user selects the desired Media.

On the same page, the user is prompted to select a Type 87, which describes sub-classifications of the Media. The field is a drop-down menu, which is populated based on the selection of Media. There are multiple values for Type for each unique instance of Media. These Type values are input for each dealership during implementation and are also stored in a metadata table. Each Type row in the metadata table contains a value for Media. To populate the Type drop-down menu, a request is sent to the Type table in the dealership database 22 to return all Type rows where the Media is equal to the value selected in the previous menu. The user selects the desired Type.

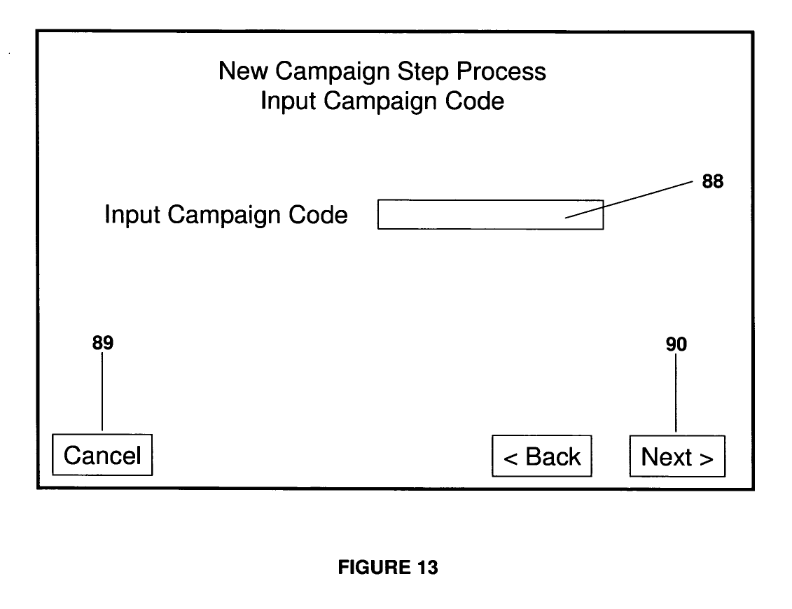

FIG. 13 is a line drawing of a screenshot of the second page of the new campaign process of the present invention. This page in the process prompts the user to input a campaign code 88. In the current embodiment, the campaign code can be any alphanumeric code of up to sixteen characters. The campaign codes uniquely identify campaigns. The application checks for duplicate campaigns as soon as the user clicks <Next> 90 to move to the next page of the process. A warning will be issued if the code entered already exists.

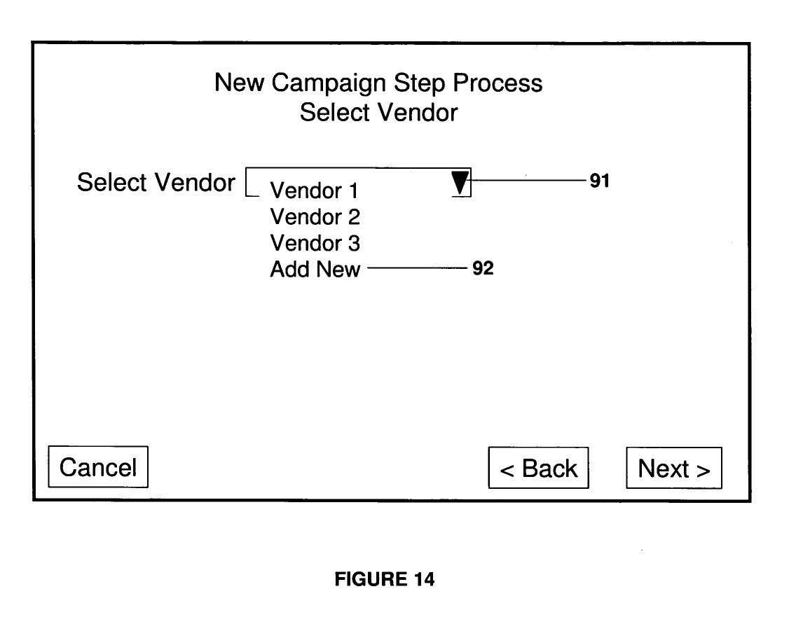

FIG. 14 is a line drawing of a screenshot of the third page of the new campaign process of the present invention. This page in the process prompts the user to select a campaign Vendor 91. The campaign vendor is selected from a drop-down menu, which lists the existing vendors and contains an option that allows the user to Add a New Vendor 92. The existing vendor names are populated by a query to the Vendor table (within the third party tables 30), which returns all rows. The user selects the vendor by highlighting the desired row in the drop-down list.

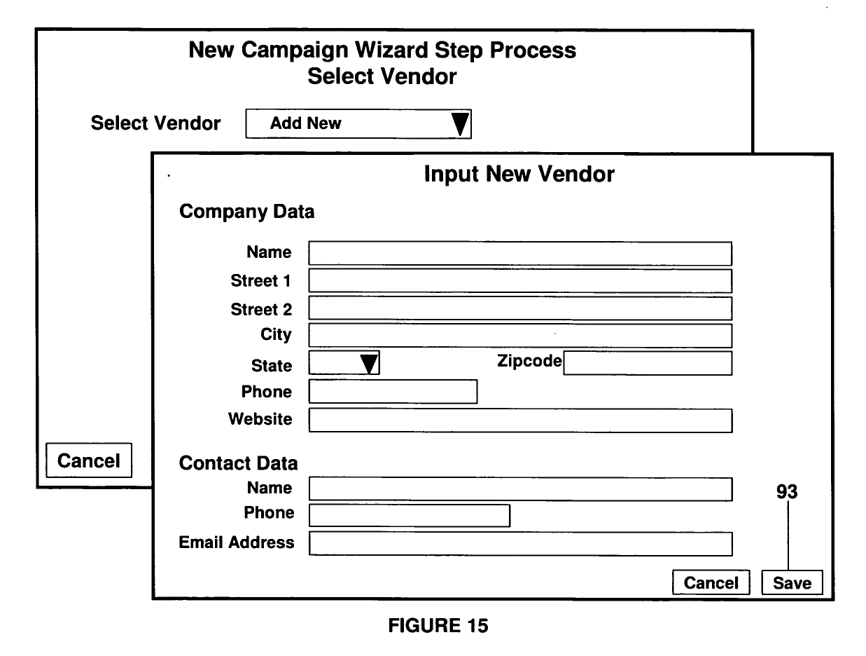

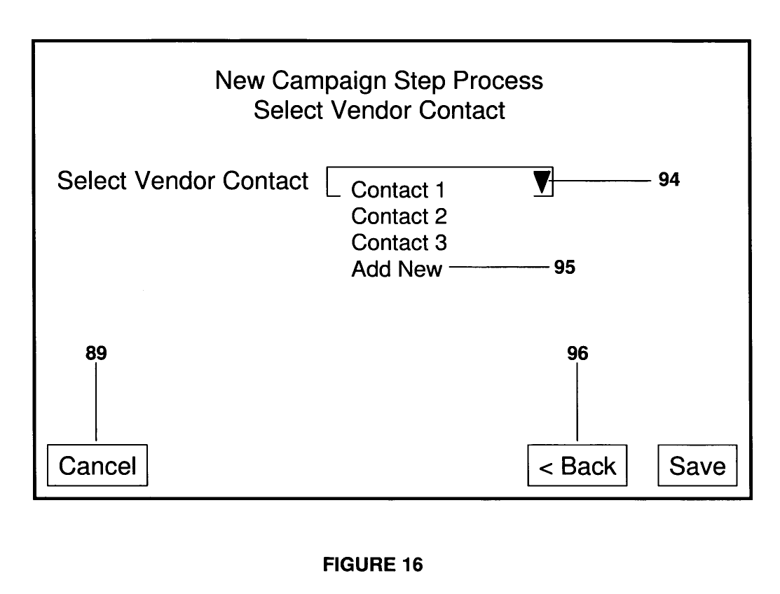

If the user selects Add New 92 from the drop-down menu, the Input New Vendor window appears, and the user can input vendor contact data. FIG. 15 is a line drawing of a screenshot of the Input New Vendor window of the present invention. When the user clicks <Save> 93 on this page, new rows are written into the Vendor (within the third party tables 30) and Contact 31 tables in the dealership database, and the new Vendor and associated contact are selected for the campaign. If the user has created a new vendor and contact on this page, the application will skip the next step in the process in which the user would select a Vendor Contact (see FIG. 16).

FIG. 16 is a line drawing of a screenshot of the fourth page of the new campaign process of the present invention. This page in the process prompts the user for the Vendor Contact 94. The vendor contact is selected from a drop-down menu, which lists existing contacts and contains an option that allows the user to Add a New Contact 95. The values for existing vendor contacts are stored in the Contact table 31 in the dealership database 22. The Contact table contains the list of representatives of the media vendors and ad agencies with whom the dealership communicates and their contact information, including mailing address, email address and phone numbers. It also contains names and contact information of people within the dealership. In addition to the contact information, each contact entry has a field that defines the type of company for which the contact works. The type of company distinguishes vendor contacts from ad agency contacts and both of those types of contacts from dealership contacts. The drop-down menu that lists the vendor contacts is populated based on the selection of vendor in the previous step. Each vendor can have multiple contacts. To populate the Contact drop-down menu, a request is sent to the Contact table 31 in the dealership database 22 to return all rows where the company type=Vendor and Vendor is equal to the value selected on the previous page. The user selects the contact by highlighting the desired row in the drop-down list.

If the user selects Add New 95 from the drop-down menu, the Input New Vendor Contact window appears, and the user can input data for the new contact.

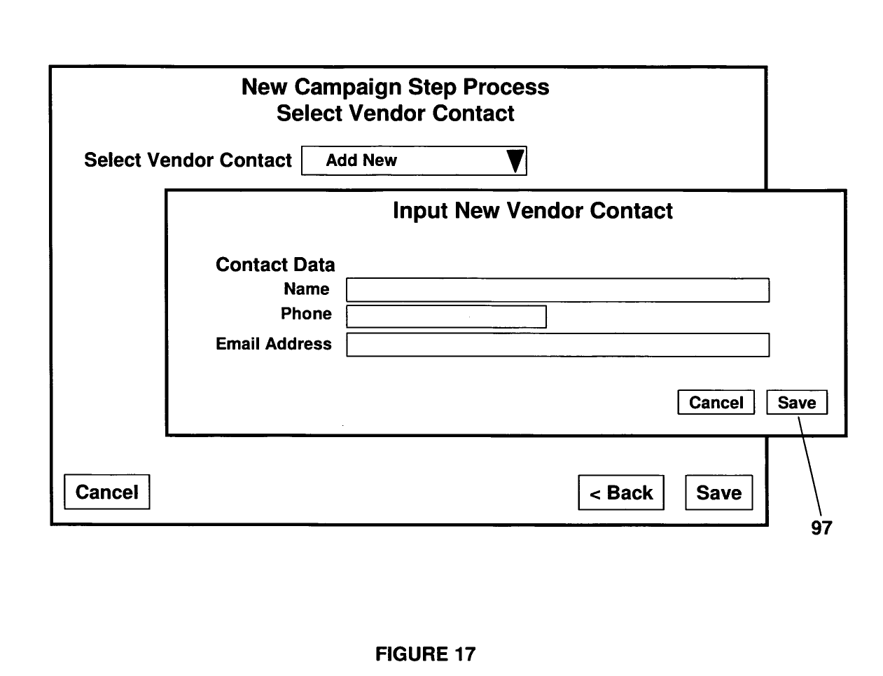

FIG. 17 is a line drawing of a screenshot of the Input New Vendor Contact window of the present invention. When the user clicks <Save> 97 on this page, a new row is written into the Contact table 31 in the dealership database 22, and the new Contact is selected for the campaign.

In addition to adding new vendors and vendor contacts by selecting the <Add New . . . > option from the drop-down menus described above, these items, as well as ad agencies and agency contacts, can be added through a separate Administrative User Interface (UI). This Administrative UI is also used to input dealership information, such as locations, departments, employees and users, and other customizable data such as the values for Type.

Pages in the process have Back 96 and Next 90 buttons to allow the user to navigate between pages. The user is restricted from continuing to the next page unless the required data has been correctly entered on the current page. When the user clicks the <Save> button (see FIGS. 16 and 17), a row is written to the Campaigns table 33 in the dealership database.

As shown in FIG. 6, once a campaign is defined, the user can define the ads that are part of the campaign. This activity is done in the Ad Development module.

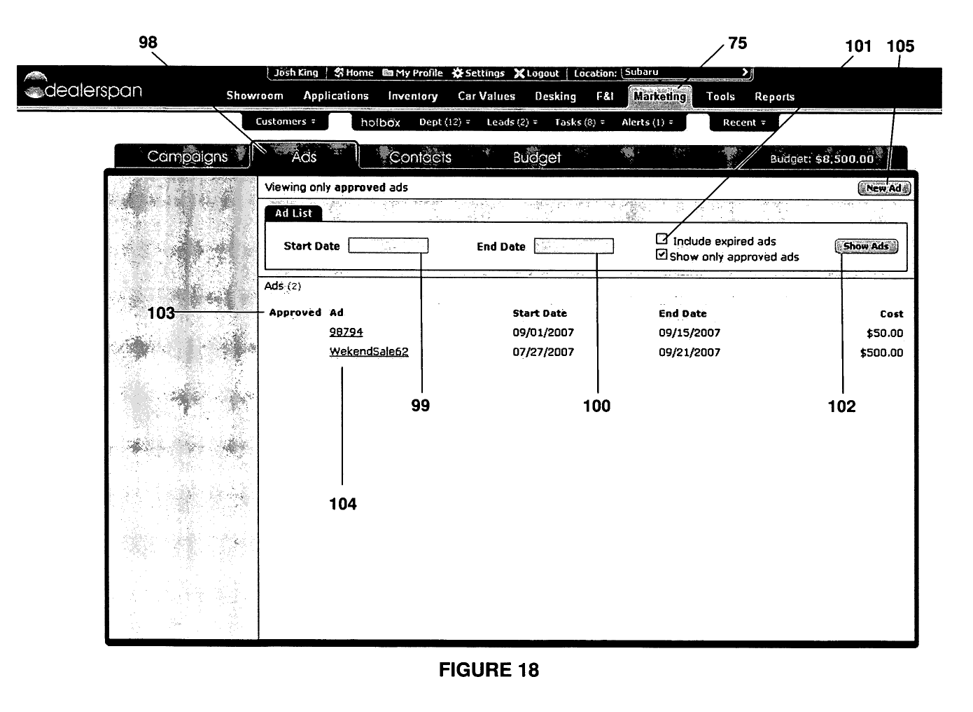

FIG. 18 is a screenshot of a representative Ad List page of the Ad Development module of the present invention. When the user clicks on the Ads tab 98 of the Marketing page 75, the browser sends a request to the web server for the Ad List page. The page sends a query to the Ads table 34 in the dealership database 22 for all current ads (ads where the start date is before the current date and the end date is after the current date) where the Status is equal to “Approved.” Users can further screen the ads by inputting parameters and requerying the database. Users can select ads that were active anytime during a specified time period by inputting start 99 and end 100 dates. If the check box “Include expired ads” 101 is checked, all ads that were active during the specified period are shown. If the box is left unchecked, only those ads that were active during the period that are still active are shown. Ads flagged as “deleted” are not shown. Clicking the Show Ads button 102 will send a query with the new parameters. The ad name, start and end dates and cost 103 are retrieved from the Ads table 34. Except for the ad name, which is generated by the invention, these data elements are input in the process described in FIG. 8 and stored in the Ads table when the ad is saved. The Ad column 104 displays links to the Ad details page (see FIG. 22), which is populated with the information for the requested ad. The New Ad button 105 issues a request for the New Ad page (see FIG. 19).

In a preferred embodiment, the Ad List page has a filter on the left panel of the page similar to the Media filter on the Campaign Summary page (see FIG. 11). The filter allows the user to select Current, Pending or Expired ads. The default filter when the page is loaded is Current. The Current filter sends a query to the Ads table 34 for ads where the current date is between the start and end dates specified for the ad. The Pending filter sends a query to the Ads table 34 for ads where the current date is prior to the start date specified for the ad. The Expired filter loads ads where the current date is after the end date specified for the ad.

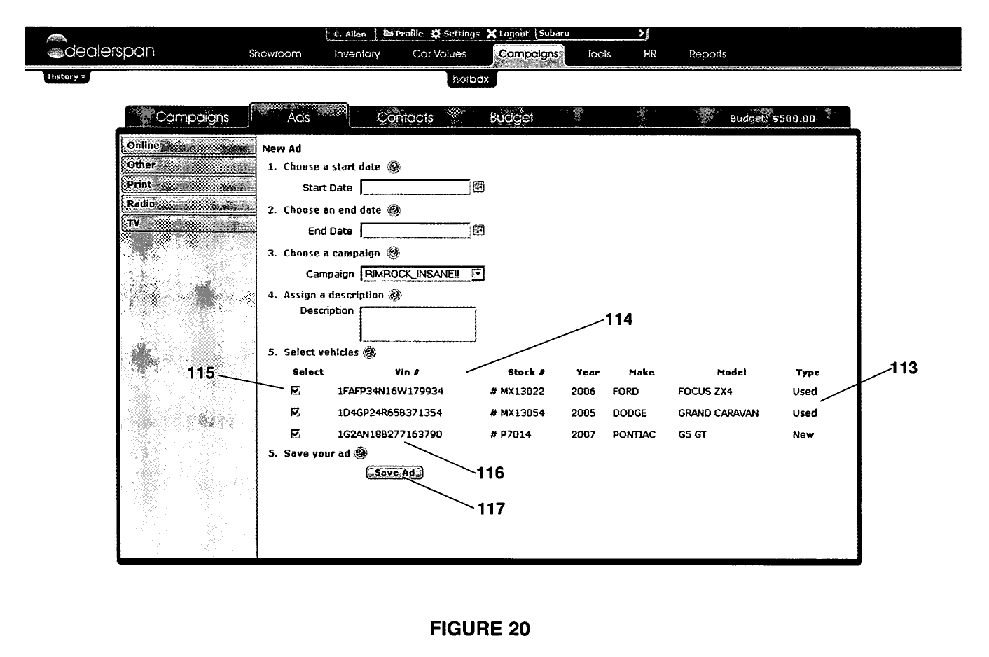

FIG. 19 is a screenshot of a representative New Ad page of the ad development module of the present invention. This is the page on which the user defines a new ad. FIG. 19 shows the New Ad page as it appears prior to the user selecting the vehicles to be included in the new ad. FIG. 20 is also a screenshot of a representative New Ad page of the ad development module of the present invention. FIG. 20 shows the New Ad page as it appears after the user has identified a list of possible vehicles to be included in the new ad. The list shown in the Select vehicles section can be compiled in one of three ways, as explained below.

On FIG. 19, the start date 106 and end date 107 fields allow users to directly type in dates or choose a date using the calendar widget. In the current embodiment, the calendar widget next to the start and end date fields is a tool made available by JavaScript. When the user clicks the calendar widget, an interactive calendar is displayed. Users can scroll from month to month using the forward and backward arrows in the corners. Clicking on a specific date enters that date into the date fields. The application checks that the start date is before the end date.

The campaign field 108 is a drop-down menu that displays all campaigns. The drop-down menu is populated by a query to the Campaigns table 33 in the dealership database 22 requesting all rows in the table that are not flagged as “deleted.” The user selects the desired campaign.

A text description of the ad can be entered into the Description box 109.

Not shown on this sample screenshot, but part of the preferred embodiment, is a field into which the user can enter an estimated cost for the new ad.

Not shown on this sample screenshot, but part of the preferred embodiment, is a drop-down field from which the user can select the Ad Contact. The Ad Contact is the person to whom the information comprising the new ad is sent after it has been compiled. The Ad Contact list is a drop-down menu, which is populated from the Contact table 31 in the Dealership database 22. Contacts with an associated company type equal to Agency or Vendor are listed. To populate the Ad Contact drop-down menu, a request is sent to the Contact table to return all rows where the company type is equal to Agency or Vendor. The user selects the desired contact.

One of the choices in the drop-down menu is to Add a New Contact. If the user elects to Add a New Contact, the Contact input window appears, and the user can input data for the new contact. When the user clicks <Save> on this page, a new row is written into the Contact table 31 in the dealership database 22, and the new Contact is selected for the ad. The invention also registers the new contact by creating a user code and password by which the new contact can access the Messaging website 54. An email containing the user code and password is generated by the invention and sent to the contact's email 55.

Also not shown on this sample screenshot but part of the preferred embodiment, is a field into which the user can enter instructions and comments about the contents and/or design of the ad.

Next to field names on all of the pages in the present invention are questions marks 110. Clicking any of the question marks calls a help page. The calls are context-sensitive, meaning that the help page displayed will be appropriate to the field associated with the question mark clicked.

When the New Ad page is initially loaded, the Select Vehicles section of the page 111 displays check boxes 112 that provide three ways of identifying the set of vehicles from which the user will select the vehicles to be included in the new ad.

If the user selects Search, a window displaying limited searching options is presented. Users can select vehicles by Year, Make, Model Payment Amount and length of time in inventory. When the user clicks <Search>, the application queries the Inventory table 29 in the dealership database 22 for vehicles that meet the selection criteria. The listing of vehicles appears in the Select Vehicles section of the New Ad page (see FIG. 20, 113). This list of vehicles is stored in memory on the server during the session but is not saved if the user logs out of the session without saving the new ad for which the vehicles have been selected.

If the user selects From Cart, the application displays the vehicles that have previously been added to the Cart. The Cart is a device for tracking vehicles of interest during the current session and is a function of the Inventory module (shown in FIG. 21). Unlike the Search option, the Cart exists independent of the new ad definition. The vehicles in the cart become associated with the new ad only when the user chooses the <From Cart> or <From Inventory> options in the Select Vehicles section of the New Ad page. When this occurs, the list of vehicles in the cart appears in the Select vehicles section of the New Ad page (see FIG. 20, 113). As with the Search option, information about vehicles placed in the cart is stored in memory on the server during the session. Vehicles in the cart can be recalled at any time during the session. If the user logs out of the session without associating the vehicles with a new ad and saving the ad, the contents of the cart are lost. The cart contents are not saved from session to session.

If the user selects From Inventory, the Inventory Detail page (see FIG. 21) is displayed. From this page users can do full inventory searches, add vehicles returned by the query to the cart, view vehicles already in their cart, and calculate price and profit. If the user elects to select vehicles <From Inventory>, the application takes them to the Inventory Detail page (see FIG. 21) where vehicles are added to the cart. If the user wants to specially price vehicles, the special sales price can be calculated or input on the Inventory Detail page (see FIG. 21, 130). From the Inventory Detail page, the user can return to the New Ad page, where the vehicles in the cart are displayed in the Select Vehicles section.

Users can use any one or several of these methods to search for vehicles and add them to the Select Vehicles section of the New Ad page. Each method adds vehicles to the section; that is, if there are three vehicles in the Cart and the user selects From Cart, the page will display three vehicles in the Select Vehicles section 111. If the user then identifies five vehicles using the Search option, five additional vehicles will appear in the Select Vehicles section, for a total of eight vehicles.

FIG. 20 is a screenshot of a representative New Ad page of the ad development module of the present invention. FIG. 20 shows the New Ad page as it appears after the user has identified a list of possible vehicles to be included in the new ad.

In the Select Vehicles section, a listing of the individual vehicles that have been selected either by search, from the cart or from inventory is shown 113. Data on each vehicle, including VIN #, Stock #, Year, Make, Model and Type 114 is displayed.

The check boxes 115 next to the VIN # in the Select Vehicles section allow the user to select or de-select vehicles for inclusion in the new ad. Users can view additional information about a vehicle by clicking on a specific row 116. This action brings up the Vehicle detail page 122 (see FIG. 21), on which the user can edit price components. (Note that reference number 122 shows the Vehicle detail as a section of the Inventory Detail page. The Vehicle detail can also be displayed as a separate page).

Once satisfied with list of vehicles to be included in the new ad, the user can save the ad definition by clicking the Save Ad 117 button. This action writes a row to the Ads table 34 in the dealership database 22 with all of the information that defined the ad, including campaign, Ad Contact, start date and end date. The application generates a new, unique Ad Identification number by querying the Ads table 34 for the highest existing Ad Identification number and adding “1” to it. The name of the ad, which appears on the Ad List page (see FIG. 18), is generated as a concatenation of the campaign code 79 and the Ad Identification number.

This Save Ad action also causes the list of vehicles to be included in the new ad 113 to be written from memory to permanent files in the dealership database. The vehicle information is written to two places. A CSV (Comma Separated Values) file (this is a standard format for tabular data) is generated containing the vehicle selection and the VIN #, Stock #, Year, Make, Model, Type and price for each vehicle. This file is the method by which the list of vehicles associated with the new ad is communicated outside the dealership, to the ad agency or the vendor. This file is stored in the Messages table 37 of the dealership database 22, as it will be an attachment to the message sent to the Ad Contact.

A Special Ad Inventory table 35 in the dealership database 22 is also updated. The list of vehicles included in the new ad, along with the Ad Identification Number of the new ad, are written to this table. The Special Ad Inventory table 35 is an interim storage location for tracking the vehicles in a newly defined ad from the time the new ad is defined until the new ad is approved. Between definition and approval, the composition of the vehicle list, as well as the prices on the vehicles, may change. Rather than updating the primary Inventory table 29 with what may be quickly outdated information, the present invention uses the Special Ad Inventory table 35 to track the new ad vehicle list.

Saving the new ad also causes the present invention to initiate communication with the Ad Contact. First, an ad definition message to the Ad Contact is generated and posted on the Messaging website, This message is assigned a unique Message ID 63 that is generated by the present invention. The Message ID, like the Ad ID 60, is generated by the MYSQL database software. The database software queries the Messages table 37 for the highest existing Message Identification number and adds “1” to it. The body of the ad definition message contains five items: the campaign code, the toll-free number for the dealership hotline, the URL for prospective customers, the estimated cost, and instructions for ad design. It also contains attachments, namely, photos and other media of the included vehicles, and the CSV file containing the list of vehicles.

The campaign code is the code input earlier in the new ad definition process. It is retrieved from the Campaigns table 33 in dealership database 22.

The toll-free number is retrieved from the Application Administration Database 21 and included in the email.

In the current embodiment, photos of the vehicles to be included in the ad are retrieved from a third party supplier of automotive information and attached to the message. The information provided by the third party to the present invention includes, but is not limited to, vehicle photographs and video, descriptive data and vehicle specifications. The table containing this third party information is integrated into the present invention and becomes part of the Media database 23.

The CSV (Comma Separated Values) file containing the list of cars to be included is posted on the Messaging website as an attachment to the message.

This original ad definition message and the subsequent replies to that message are stored in the Messages table 37 in the dealership database 22. The original message has a unique Message ID 63, and all subsequent messages in the thread are associated with the original message via this ID.

Next, the present invention sends an email directly to the Ad Contact containing the URL (Uniform Resource Locator) of the Messaging website. As noted above, the URL for the Messaging website is generated as a combination of the Message ID 63 and the Ad ID 60. The email address for the Ad Contact is retrieved from Contact table 31 in the dealership database 22.

FIG. 21 is a screenshot of a representative Inventory Detail page. This page can be called by clicking the Inventory tab 118. The page is part of the Inventory Control module 4, and it is called from the New Ad page (FIG. 19) of the ad development module when the user selects From Inventory in the Select Vehicles section 112.

In the current embodiment of the present invention, there are four sections on the Inventory Detail page: the Cart Section 119, the Search Section 120, the Vehicle Listing Section 121, and the Vehicle Detail Section 122. The Cart Section 119 shows a summary list of vehicles already in the cart. The Search Section 120 presents the user with three ways to choose vehicles (discussed below). The Vehicle Listing Section 121 shows the vehicles that were returned from the query. The Vehicle Detail Section 122 displays the details of the individual vehicle selected from the Vehicle Listing Section 121.

The Cart 119 is populated by clicking the button on the far left of a row in the Vehicle Listing Section 123. A “+” in this column indicates that the vehicle is not currently in the cart. Clicking the “+” will add the vehicle to the cart. An “x” in this column indicates that the vehicle is already in the cart. Clicking on the “x” will delete the vehicle from the cart. The Cart section 119 is refreshed to include or exclude the vehicle, and the indicator on the left of the row is changed. In the Cart Section 119 summary information is shown, including the vehicle stock number and a flag indicating whether the vehicle is already included in an ad. The flag is a static indicator. From this window the user can also delete the vehicle from the cart by clicking the “x” in the Delete column.

The Recall button 124 allows the user to focus on and compare the vehicles in the Cart. Clicking the Recall button for the first time on the Inventory Detail page will clear the Vehicle Listing Section 121 and display only the selected vehicle in the Vehicle Listing Section 121 and the Vehicle Detail Section 122. Clicking the Recall button next to subsequent vehicles will add that vehicle to the Vehicle Listing section and refresh the Vehicle Detail section with the newly selected vehicle. This allows the user to view only the vehicles in the Cart in the Vehicle Listing section, where the information provided is much more detailed than that in the Cart section.

The Menu button 125 is the means by which users navigate from the Inventory Detail page to other pages. The primary functions of the Inventory Detail page are to allow the user to compile lists of vehicles and directly edit information on the selected vehicles. A key use of this functionality within the present invention is to identify and price vehicles to be featured in “specials.” The Menu button 125 takes the user from the Inventory Detail page to the page on which these specials are defined and lists the selected vehicle in the Vehicle Listing section of that page.

Using the Menu buttons involve two steps. Each Menu button gives the user the choice of acting on the single vehicle in the row where the Menu button was clicked or on the entire Cart. The user then chooses whether the vehicle or vehicles are being marked for inclusion in an ad (which will return them to the New Ad page, FIG. 20), for listing on one of several auction sites, or as a web special on the dealership website. The selected vehicles will be displayed on the appropriate page in the Select Vehicles section 113.

The Search Section 120 of the Inventory Detail page provides users with three ways to filter vehicles displayed in the Vehicle Listing Section 121. The Advanced Search tab 126 allows users to specify criteria for vehicle type (New, Used or Both), Stock and VIN numbers, price or payment ranges, year and mileage. Quick Search 127 allows users to specify criteria for Year, Make, Model Payment Amount and length of time in inventory. The Specials tab 128 shows only vehicles that are in listed in any ad, auction or web special. The Search button 129 submits the request to the server.

The filtered results are returned to the Vehicle Listing Section 121. When this page first loads, prior to the user launching a search, the Vehicle Listing Section displays all of the vehicles in inventory. For each vehicle, the invention retrieves data from the Inventory table 29 in the dealership database 22, including the stock number, year, make, model, mileage, length of time in inventory, pricing information and valuation information, as well as a number of indicators showing the vehicle's ad status and service status. Data that is shown in the Vehicle Detail section 122 is retrieved at the same time so that when a vehicle is selected for display, there is no need to re-query the database.

In the pricing subsection 130 of the Inventory Detail page, the invention displays a total base cost FIG. 131, which includes the base cost of the vehicle (“Hc” stands for “Hard cost”) plus “pack” (an average cost, estimated by the dealership, of prepping and processing a vehicle), and the Manufacturer Suggested Retail Price. In this section the user can input figures for Markup, Rebate and Discount. When the user clicks on any of these three fields, a small window similar to the calculation window 133 appears. The user can enter any or all of the figures and then click the <Save> button in the window. The invention calculates the sales price. Clicking on the <Sale> button 132 at the top of the column pops up the mini-desk calculation window 133, which allows the user to calculate the payment based on the sale price, the down payment and the financing interest rate and term.

The valuation subsection 134 shows the user valuations from various third party sources, including, but not limited to, Kelly Blue Book (KBB) and National Automotive Dealer Association (NADA). Tooltips can be called in various locations on the page. Tooltips are context-sensitive windows that are called by placing the cursor over a field. In one embodiment, the valuation tooltip 135 indicates the price/value relationships for a specific vehicle. The list of vehicles may span several pages, so a scroll bar at the top of the section 136 allows the user to navigate the pages.

The Vehicle Detail section 122 is populated when a specific car is selected from the Vehicles Listing section 121 or when the Recall button 124 is clicked in the Cart section 119. This window displays additional data from the Inventory table 29. Additional information displayed includes VIN number and details on the color and trim. The photo is retrieved from the Media database 23 at the time the vehicle is selected for viewing.

The Profit Center subsection 137 of the Vehicle Detail section allows users to calculate the potential profit based on the cost of the vehicle and an estimated price. The estimated price is calculated as the Finance Total plus the Down payment. The Finance Total is calculated as the Book Value times the loan-to-value (LTV) ratio. The cost of the vehicle is the Hc+pack FIG. 131 shown in the pricing subsection. Sales profit is the Finance Total+Down less Hc+pack. In the Profit Center subsection, users can input the LTV %. The Book Value and the Hc+pack are pulled from the Inventory table 29. The Down payment is input by the user in the Mini Desk calculation window 133. For example, assume that the Book Value of the vehicle is $20,000 and the Hc+pack amount is $17,000. If the user inputs an LTV ratio of 110% and a down payment of $2,000, the Sales Profit is calculated as (20,000*110%)÷2,000−$17,000 or $7,000.

When the user returns to the New Ad page (FIG. 20) by choosing the Ad Development module after clicking the Menu button 125, the vehicles that are in the Cart appear in the Select Vehicles section 113. From there, users can choose to include or exclude them from the ad.

FIG. 22 is a screenshot of a representative Ad Details page in the Ad Development module of the present invention. In this example, the ad in question has already been approved. This page can be called from the Campaign Development module when the user clicks on a specific ad on the Campaign Summary page (FIG. 11) or from the Ad Development module when the user selects a specific ad on the Ad List page (FIG. 18). In the current embodiment, the Ad Details page has four sections. The Ad Details section 138 shows the administrative details of the ad, including the ad name and description, the campaign code for the campaign to which the ad belongs, and the ad cost 139. The Dates and Approvals section 140 displays start and end dates and approval information. The Messaging section 141 displays the communication history regarding the ad. The Inventory section 142 displays the detailed information for all vehicles included in the ad. The user chooses to display the Messaging section or the Inventory section by clicking on the tabs below the Ad Details section.

On the representative screenshot shown in FIG. 22, the Messaging section 141 is displayed. The initial new ad message from the dealership to the Ad Contact 143 submitting the ad details and instructions is shown, followed by replies to the initial message. Attachments 144 to the initial new ad message include the inventory list in CSV file format, photos and other media such as 360-degree views of the vehicles and video.

When the proof of the ad has been completed, it is returned as an attachment to a message from the Ad Contact to the user. Not shown in this screenshot, but part of the preferred embodiment, is an <Approve Ad> button that appears next to any reply email from the Ad Contact that has an attachment. The user can click the <Approve Ad> button anywhere in the messaging thread, which will cause the attached proof to be the approved ad. When the user clicks the <Approve Ad> button, a pop-up up window appears. This window displays two fields: the Cost field and the Approval Date field. In the Cost field, the user can modify the estimated cost, initially entered on the New Ad page, to reflect any changes in costs since the ad was defined. The current date appears in the Approval Date field. The Approval Date in the current invention is used to determine when the cost of the ad is subtracted from the available advertising budget. If the user wishes to have the ad cost deducted on a date different from the date on which the ad is approved, he can modify the Approval date in this pop-up window. The reason for changing this date is to allow the remaining budget to more accurately reflect the actual timing of the expense. For example, if the actual expense for producing the ad did not have to be paid until 45 days after the ad was approved, the user might not want the expense amount to be deducted from the budget until it was actually paid.

When the user clicks <Save> on this pop-up window, the invention writes the updated cost and the Approval Date to the Ads table 34 in the dealership database 22. When the ad is approved, the Inventory table 29 in the dealership database 22 is updated with flags indicating that the vehicle has been included in an ad. The vehicle price to be shown in the ad is also updated in the Inventory table. The Ad Contact is sent the approved proof, and if the Ad Contact is an ad agency contact, then a campaign contact at the media vendor is also sent a proof.

The Edit Ad button 145 at the top of the page allows the user to change the Ad Contact and the start and end dates. This button is non-operative if the ad has already been approved.

After the ad has been approved, the user can still change the cost of an ad and the date on which the cost of the ad is deducted from the budget. The pop-up window that appears when the user clicks the <Approve Ad> button can also be accessed by clicking on the Cost field 139. If additional costs are incurred after the approval of the ad, the user enters the new total cost in this window. When this window is accessed after the approval process, the date that appears in the Approval Date window is the date that was entered when the ad was approved. The user can enter a new date, which will have the effect of changing the date on which the ad cost is deducted from the budgeted amount. The user can also change this date by clicking on the Edit Approval button 146.

FIG. 23 is a screen shot of a representative New Budget Entry page in the Ad Development module of the present invention. This page is the means by which the user, within the ad development process, allocates money to the advertising budget. This part of the present invention is not intended to be a comprehensive financial management system. Rather, it provides the advertising manager within the dealership a way of tracking advertising costs against a budgeted amount.

The sum of the budget entries constitutes the total amount allocated to advertising for a dealership for its fiscal year. The cost of ads whose approval dates are within the fiscal year is deducted from this total budgeted amount. The net amount is the budget figure that appears on the Campaign Summary page (FIG. 11, 78).

For example, suppose the user (the advertising manager at the dealership) budgets $1,000 per quarter for advertising. At the beginning of the first quarter, $1,000 would be entered into the New Budget Entry screen. This amount is saved to the Budget table in the dealership data tables 25 of the dealership database 22. On February 25^{th}, an ad costing $600 is approved. This amount is saved into the Ads table 34 of the dealership database 22. On March 1^{st}, if the user loaded the Campaign Summary page (FIG. 11), the amount appearing in the Budget field 78 would be $400. Suppose the user then approves an ad on March 13, costing $500, the expense of which would not actually be incurred until April 9^{th}. The cost of this ad puts total advertising cost for the quarter ($ 1,100) over the budgeted amount ($1,000) even though the expense occurs in the following quarter, after another $1,000 will have been added to the budget. In this case, the user would want to edit the Approval Date, changing it to April 9 so that the expense is deducted from the budgeted amount when it actually occurs and after an additional $1,000 is added to the budgeted amount.

FIG. 23 is divided into two sections. The first section 147 is the data entry section, where the user adds a new budget entry. The second section is the budget entries section 148, which shows all of the entries made within a specified date range.

In the data entry section 147, fields allow the user to enter a Description 149 and Amount 150. A drop-down menu 151 prompts the user for the location associated with this budget amount. This menu is populated from the Locations table in the dealership data tables 25 in the dealership database 22. When the user clicks the <Save Entry> button 152, the budgeted amount is saved in the Budget table in the dealership data tables 25 in the dealership database 22.

The budget entries section 148 displays information on existing entries, including the location, the description, the date on which the entry was made, and the amount. Note that the date is not entered by the user. The date field for each entry is automatically set to the date on which the entry is made. Clicking the Delete button 153 removes the entry from the dealership database 22. The date range field 154 allows users to filter the entries, showing only those entries whose dates are within the specified range. The arrows at the either end of the date range field provide the means for adjusting the beginning and ending dates of the range.

The Total field 155 at the bottom of the page displays the total of the budget entries shown.

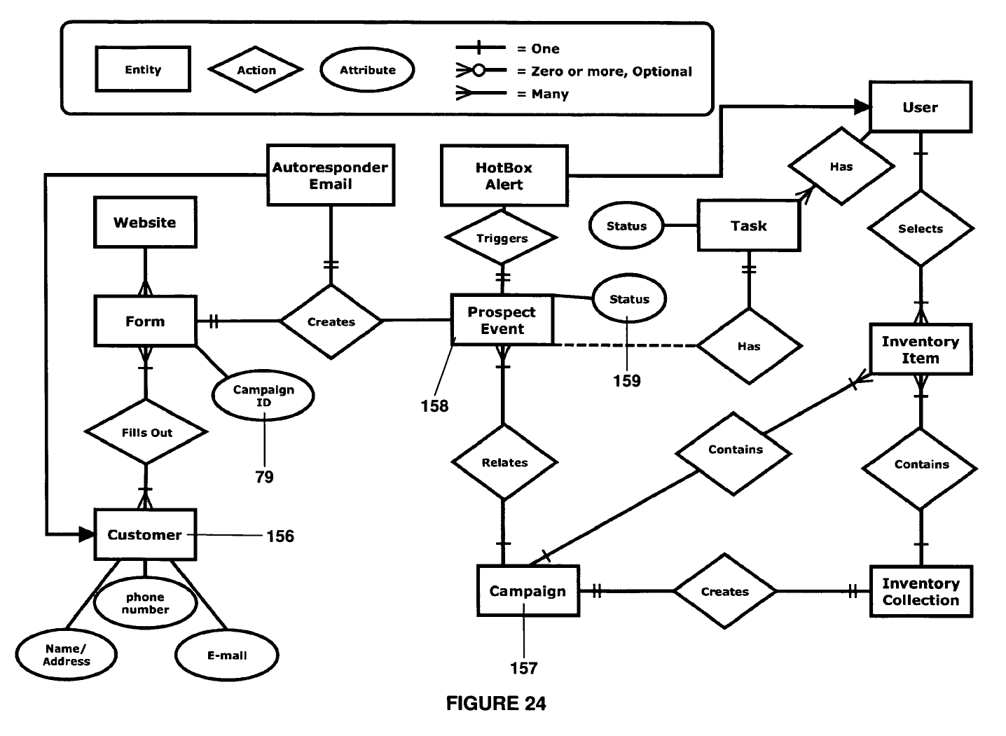

FIG. 24 is a flow diagram that shows how advertising expenditure can be linked to customer activity through the dealership database 22. A customer is uniquely identified by his or her name, address, phone number and email address 156. These fields are collectively referred to as the customer identifiers. This data is gathered and stored in the Customers table 27 in the dealership database 22 when a customer makes contact with a dealership. If the contact is made by phone or by an in-person visit, the customer is asked for the data, and the information is keyed into the present invention by dealership personnel. If the contact is made via the web, customers are asked to fill out a form. In all of these interactions, the customers are asked for the data that constitutes their customer identifier.

As noted in the description of the campaign and ad development process, all ads are associated with a single campaign 157 identified by the campaign code 79. Further, the cost for each ad is gathered during the new ad development process and stored with the ad details in the Ads table 34 of the dealership database 22. This means that the cost of any campaign can be calculated simply by querying the Ads table 34 for all of the ads associated with a particular campaign code and then summing the costs.

Users can use these data relationships to calculate costs along any data dimension that is defined for ads or campaigns. For example, three other data elements that are defined in the campaign development process and stored with the campaign definition are Media 86, Type 87 and Vendor 91. Dealerships can also use the costs associated with the ads to calculate the costs of advertising by Media, Type and Vendor. The user can retrieve the various costs by querying the Campaigns table 33 for all campaigns associated with a particular Media, Type and/or Vendor, then querying the Ads table 34 for the sum of the costs of all ads associated with the resulting campaigns.

The costs of advertising can also be linked to customers and prospect events. Any customer contact, such as a phone call, filling out a web form, scheduling or taking a test drive, causes a separate prospect event 158 to be filled out, either automatically by the present invention or manually by dealership personnel. Each of these prospect event records is stored in the Prospect Events table 28 in the dealership database 22, encoded with a status code 159 that indicates type of event (test drive, deal structuring, financing, for example), and associated with the customer identifiers. Through these status codes, the dealership can track how far through the sales cycle a particular customer progressed.

When customers first contact the dealership, in addition to their customer identifiers, they are asked for the campaign code associated with the ad that brought them to the dealership. This code is also stored along with the customer identifiers in the Customers table 27 in the dealership database.

The linkages in the data—customer to prospect events and status, customer to campaign code, campaign code to ads, ads to advertising cost, campaign code to media, type and vendor—enable the dealership to analyze the effectiveness of a campaign across many dimensions. “Effectiveness” can be measured by how many customers make contact with the dealership as well as how far through the sales cycle the prospective customers get. This information, in turn, can be linked to the cost of the campaigns that attracted the customers in the first place.

For example, suppose both Campaigns A and B cost $100 (calculated by adding the costs of ads associated with each campaign). Campaign A was a radio campaign (identified by the Media) that brought in four customers (customer identifiers associated with a particular campaign), none of whom got past the test driving stage (identifiable by querying the customer contact events for each customer and noting the status codes). Campaign B was a newspaper ad that brought in ten customers, eight of which got to the deal structuring stage and four of whom purchased automobiles. Clearly, Campaign B was more successful. Additional analysis may demonstrate that, in general, newspaper ads are more effective than radio ads, causing the dealership to reallocate its advertising expenditure.

Note that the ability to link the campaign to prospective customers is only effective if the customer is able to supply the campaign code. If the customer does not supply a campaign code, a default code is supplied by the present invention and saved with the customer contact events.

All screenshots are provided for illustrative purposes only and are not intended to limit the invention in any respect. Whenever a claim refers to a “page,” that page is not limited to any particular user interface or configuration, as long as it provides the functionality recited in the claim.

Although the preferred embodiments of the present invention have been shown and described, it will be apparent to those skilled in the art that many changes and modifications may be made without departing from the invention in its broader aspects. The appended claims are therefore intended to cover all such changes and modifications as fall within the true spirit and scope of the invention.

We claim:

1. A system for developing and managing advertisement campaigns comprising:
(a) an ad development module;
(b) a campaign development module;
(c) an inventory control module;
(d) a messaging module;
(e) a prospect event tracking module; and
(f) a central data store;
wherein each module accesses the central data store;
wherein the central data store comprises data on vehicles in inventory, existing customers, prospective buyers, advertisements and advertisement campaigns, contacts, communications, and marketing and/or sales materials from manufacturers;
wherein the campaign development module allows users to create new ad campaigns;
wherein the ad development module enables users to create new advertisements;
wherein the inventory control module allows a user to search for vehicles that meet certain criteria and to view data on selected vehicles;
wherein the messaging module manages communications within a dealership, between the dealership and customers, and between the dealership and vendors; and
wherein the prospect event tracking module links prospective buyers to interactions with the dealership.

2. The system of claim 1, wherein the central data store comprises an administration database, one or more dealership databases, and one or more databases containing data that is common across dealerships;
wherein the dealership databases contain data that is specific to a particular dealership;
wherein the common databases comprise a media database and a third party application support database; and
wherein each dealership implements its own dealership database to ensure complete separation of all business data from other dealerships.

3. The system of claim 1, wherein each ad is associated with a particular campaign; and
wherein each campaign is assigned a campaign code.

4. The system of claim 3, wherein the campaign code is used to link prospective buyers to the ads that introduced them to the dealership.

5. The system of claim 3, wherein each prospective buyer is assigned a customer identifier; and
wherein the campaign codes and prospect events are stored in the dealership database and linked by the customer identifiers.

6. The system of claim 1, wherein to create a new ad, the user selects a campaign, selects the vehicles to be included in the ad, selects an ad contact, specifies a time period over which an ad is to be run, enters an estimated cost for the ad, enters comments and/or instructions regarding production of the ad, and saves the ad as a new ad.

7. The system of claim 6, wherein once the new ad is saved, it is written to the dealership database;
wherein when a new ad is saved, the system automatically generates a new ad message that is posted to a web messaging page;
wherein when a new ad is saved, the system automatically generates an ad identifier and a new ad message identifier; and
wherein when a new ad is saved, the system automatically sends an email to the ad contact with the address for the web messaging page on which the new ad message is posted.

8. The system of claim 7, wherein a web messaging page is created for each new ad;
wherein the ad comprises contents and a design, and wherein the web messaging page allows the user and the ad contact to communicate with each other regarding the ad contents and design by posting messages to the web messaging page;
wherein the ad identifier and the new ad message identifier are used to generate the address for the web messaging page; and
wherein all messages concerning the ad are assigned identifiers related to the new ad message identifier and stored in the dealership database.

9. The system of claim 7, wherein the new ad message comprises a campaign code, the address for the web messaging page, an estimated cost of the new ad, and comments and/or instructions regarding the contents and/or design of the ad; and
wherein a file comprising a list of the vehicles to be included in the ad is attached to the new ad message.

10. The system of claim 9, wherein the marketing and/or sales materials from manufacturers are attached to the new ad message.

11. The system of claim 7, wherein the ad contact reviews the new ad message, produces a proof of the ad, and posts a message with the proof attached to the message on the web messaging page;
wherein the user reviews and approves or declines the proof, and if the proof is declined, provides reasons for declining;
wherein an iterative process continues until the ad is approved;
wherein when the ad is approved, if the ad contact is a media vendor, then the system sends an email with the approved proof to the ad contact; and
wherein when the ad is approved, if the ad contact is not a media vendor, then the system sends an approval notification to the ad contact and an email with the approved proof to a contact at the media vendor for publication or airing of the ad.

12. The system of claim 11, further comprising a new budget entry page,
wherein when an ad is approved, the system automatically assigns an approval date to the ad;
wherein the estimated cost of the ad and the approval date are modifiable;
wherein the user enters a total budgeted amount for advertising on the new budget entry page;
wherein the cost of ads whose approval dates are within a dealership's fiscal year are deducted from the total budgeted amount to generate a net amount; and
wherein the net amount is reflected on a campaign summary page of the campaign development module.

13. The system of claim 3, wherein a cost is associated with each campaign, and wherein the cost of a campaign is calculated by querying the dealership database for all ads associated with a particular campaign code.

14. The system of claim 13, wherein the system allows the user to calculate the costs associated with one or more campaigns by media, media type and/or vendor.

15. The system of claim 3, wherein the system allows a dealership to link customers to prospect events, customers to campaign codes, campaign codes to ads, ads to advertising costs, and campaign codes to media/type/vendor data; and
wherein the media data represents the media in which an ad appears, the type data is a sub-class of media, and the vendor data reflects the media vendor.

16. The system of claim 1, wherein the campaign development module comprises a campaign summary page;
wherein a media vendor is associated with each campaign, and wherein the campaign summary page identifies the media vendor;
wherein the campaign summary page identifies a media type, campaign code, vendor contact and dealership location for each campaign;
wherein the user can create a new campaign, edit an existing campaign, create a new ad, or delete a campaign from the campaign summary page;
wherein if the user elects to create a new campaign, a new campaign process is called;
wherein the new campaign process assists users in defining new campaigns; and
wherein the new campaign process comprises one or more pages that guide the user through the definition of a new campaign.

17. The system of claim 1, wherein the ad development module comprises an ad list page;
wherein the ad list page lists all ads that have been approved;
wherein users can screen ads by start and end dates and/or ad status; and
wherein ad status is current, pending or expired.

18. The system of claim 7, wherein the ad development module comprises an ad list page and an ad details page;
wherein the campaign development module comprises a campaign summary page;
wherein the ad details page is called when the user selects a specific ad on the ad list page or the campaign summary page;
wherein the ad details page comprises an ad details section, a dates and approvals section, a messaging section, and an inventory section; and
wherein the messaging section shows the initial new ad message from the dealership to the ad contact and all subsequent messages related to the initial new ad message.

19. The system of claim 1, wherein the ad development module comprises a new ad page;
wherein the new ad page assists users in defining new ads to be included in a campaign;
wherein the user selects vehicles to be included in the new ad;
wherein the vehicles are selected by search, from a cart and/or from inventory;
wherein the user inputs start and end dates for the new ad;
wherein the user associates the ad with a campaign;
wherein the user enters an estimated cost for the ad;
wherein the user selects an ad contact; and
wherein each ad comprises contents and/or design, the user enters comments and/or instructions concerning the contents and/or design of the ad.

20. The system of claim 19, wherein if the user elects to select vehicles from inventory, the system calls an inventory details page;
wherein the inventory details page comprises a cart section, a search section, a vehicle listing section, and a vehicle detail section; and
wherein the user can add vehicles to the cart from the inventory details page.

21. The system of claim 20, wherein the inventory details page displays a base cost and a manufacturer's suggested retail price for each vehicle;
wherein the inventory details page allows a user to input markup, rebate and discount amounts; and
wherein the system calculates a sales price for the vehicle.

22. The system of claim 21, wherein the system further comprises a mini-desk calculation window that allows the user to calculate payment based on sales price, down payment and financing interest rate and term.

23. The system of claim 20, wherein the vehicle detail section comprises a valuation subsection and a profit center subsection;
wherein the valuation subsection displays vehicle valuation figures from third party sources; and
wherein the profit center subsection allows the user to calculate the potential profit associated with a particular transaction.

24. A system for developing and managing advertisement campaigns comprising:
(a) an ad development module;
(b) a campaign development module;
(c) an inventory control module;
(d) a messaging module;
(e) a prospect event tracking module; and
(f) a central data store;
wherein each module accesses the central data store;
wherein the central data store comprises data on products in inventory, existing customers, prospective buyers, advertisements and advertisement campaigns, contacts, communications, and marketing and/or sales materials from manufacturers;
wherein the campaign development module allows users to create new ad campaigns;
wherein the ad development module enables users to create new advertisements;
wherein the inventory control module allows a user to search for products that meet certain criteria and to view data on selected products;
wherein the messaging module manages communications within a sales entity, between the sales entity and customers, and between the sales entity and vendors; and
wherein the prospect event tracking module links prospective buyers to interactions with the sales entity.

25. The system of claim 24, wherein the central data store comprises an administration database, one or more sales entity databases, and one or more databases containing data that is common across sales entities;
wherein the sales entity databases contain data that is specific to a particular sales entity;
wherein the common databases comprise a media database and a third party application support database; and
wherein each sales entity implements its own sales entity database to ensure complete separation of all business data from other sales entities.

26. The system of claim 24, wherein each ad is associated with a particular campaign; and
wherein each campaign is assigned a campaign code.

27. The system of claim 26, wherein the campaign code is used to link prospective buyers to the ads that introduced them to the sales entity.

28. The system of claim 26, wherein each prospective buyer is assigned a customer identifier; and
wherein the campaign codes and prospect events are stored in the sales entity database and linked by the customer identifiers.

29. The system of claim 24, wherein to create a new ad, the user selects a campaign, selects the products to be included in the ad, selects an ad contact, specifies a time period over which an ad is to be run, enters an estimated cost for the ad, enters comments and/or instructions regarding production of the ad, and saves the ad as a new ad.

30. The system of claim 29, wherein once the new ad is saved, it is written to the sales entity database;
wherein when a new ad is saved, the system automatically generates a new ad message that is posted to a web messaging page;
wherein when a new ad is saved, the system automatically generates an ad identifier and a new ad message identifier; and
wherein when a new ad is saved, the system automatically sends an email to the ad contact with the address for the web messaging page on which the new ad message is posted.

31. The system of claim 30, wherein a web messaging page is created for each new ad;
wherein the ad comprises contents and a design, and wherein the web messaging page allows the user and the ad contact to communicate with each other regarding the ad contents and design by posting messages to the web messaging page;
wherein the ad identifier and the new ad message identifier are used to generate the address for the web messaging page; and
wherein all messages concerning the ad are assigned identifiers related to the new ad message identifier and stored in the sales entity database.

32. The system of claim 30, wherein the new ad message comprises a campaign code, the address for the web messaging page, an estimated cost of the new ad, and comments and/or instructions regarding the contents and/or design of the ad; and
wherein a file comprising a list of the products to be included in the ad is attached to the new ad message.

33. The system of claim 32, wherein the marketing and/or sales materials from manufacturers are attached to the new ad message.

34. The system of claim 30, wherein the ad contact reviews the new ad message, produces a proof of the ad, and posts a message with the proof attached to the message on the web messaging page;
wherein the user reviews and approves or declines the proof, and if the proof is declined, provides reasons for declining;
wherein an iterative process continues until the ad is approved;
wherein when the ad is approved, if the ad contact is a media vendor, then the system sends an email with the approved proof to the ad contact; and
wherein when the ad is approved, if the ad contact is not a media vendor, then the system sends an approval notification to the ad contact and an email with the approved proof to a contact at the media vendor for publication or airing of the ad.

35. The system of claim 34, further comprising a new budget entry page,
wherein when an ad is approved, the system automatically assigns an approval date to the ad;
wherein the estimated cost of the ad and the approval date are modifiable;
wherein the user enters a total budgeted amount for advertising on the new budget entry page;
wherein the cost of ads whose approval dates are within a sales entity's fiscal year are deducted from the total budgeted amount to generate a net amount; and
wherein the net amount is reflected on a campaign summary page of the campaign development module.

36. The system of claim 26, wherein a cost is associated with each campaign, and wherein the cost of a campaign is calculated by querying the sale entity database for all ads associated with a particular campaign code.

37. The system of claim 36, wherein the system allows the user to calculate the costs associated with one or more campaigns by media, media type and/or vendor.

38. The system of claim 26, wherein the system allows a sales entity to link customers to prospect events, customers to campaign codes, campaign codes to ads, ads to advertising costs, and campaign codes to media/type/vendor data; and
wherein the media data represents the media in which an ad appears, the type data is a sub-class of media, and the vendor data reflects the media vendor.

39. The system of claim 24, wherein the campaign development module comprises a campaign summary page;
wherein a media vendor is associated with each campaign, and wherein the campaign summary page identifies the media vendor;
wherein the campaign summary page identifies a media type, campaign code, vendor contact and sales entity location for each campaign;
wherein the user can create a new campaign, edit an existing campaign, create a new ad, or delete a campaign from the campaign summary page;
wherein if the user elects to create a new campaign, a new campaign process is called;
wherein the new campaign process assists users in defining new campaigns; and
wherein the new campaign process comprises one or more pages that guide the user through the definition of a new campaign.

40. The system of claim 24, wherein the ad development module comprises an ad list page;
wherein the ad list page lists all ads that have been approved;
wherein users can screen ads by start and end dates and/or ad status; and
wherein ad status is current, pending or expired.

41. The system of claim 30, wherein the ad development module comprises an ad list page and an ad details page;
wherein the campaign development module comprises a campaign summary page;
wherein the ad details page is called when the user selects a specific ad on the ad list page or the campaign summary page;
wherein the ad details page comprises an ad details section, a dates and approvals section, a messaging section, and an inventory section; and
wherein the messaging section shows the initial new ad message from the sales entity to the ad contact and all subsequent messages related to the initial new ad message.

42. The system of claim 26, wherein the ad development module comprises a new ad page;
wherein the new ad page assists users in defining new ads to be included in a campaign;
wherein the user selects products to be included in the new ad;
wherein the products are selected by search, from a cart and/or from inventory;
wherein the user inputs start and end dates for the new ad;
wherein the user associates the ad with a campaign;
wherein the user enters an estimated cost for the ad;
wherein the user selects an ad contact; and
wherein each ad comprises contents and/or design, the user enters comments and/or instructions concerning the contents and/or design of the ad.

43. The system of claim 42, wherein if the user elects to select products from inventory, the system calls an inventory details page;
wherein the inventory details page comprises a cart section, a search section, a product listing section, and a product detail section; and
wherein the user can add products to the cart from the inventory details page.

44. The system of claim 43, wherein the inventory details page displays a base cost and a manufacturer's suggested retail price for each product;
wherein the inventory details page allows a user to input markup, rebate and discount amounts; and
wherein the system calculates a sales price for the product.

45. The system of claim 44, wherein the system further comprises a mini-desk calculation window that allows the user to calculate payment based on sales price, down payment and financing interest rate and term.

46. The system of claim 43, wherein the product detail section comprises a valuation subsection and a profit center subsection;
wherein the valuation subsection displays vehicle valuation figures from third party sources; and
wherein the profit center subsection allows the user to calculate the potential profit associated with a particular transaction.

47. A method for developing and managing advertisement campaigns comprising:
(a) an ad development module;
(b) a campaign development module;
(c) an inventory control module;
(d) a messaging module;
(e) a prospect event tracking module; and
(f) a central data store;
wherein each module accesses the central data store;
wherein the central data store comprises data on vehicles in inventory, existing customers, prospective buyers, advertisements and advertisement campaigns, contacts, communications, and marketing and/or sales materials from manufacturers;
wherein the campaign development module allows users to create new ad campaigns;
wherein the ad development module enables users to create new advertisements;
wherein the inventory control module allows a user to search for vehicles that meet certain criteria and to view data on selected vehicles;
wherein the messaging module manages communications within a dealership, between the dealership and customers, and between the dealership and vendors; and
wherein the prospect event tracking module links prospective buyers to interactions with the dealership.

48. The method of claim 47, wherein the central data store comprises an administration database, one or more dealership databases, and one or more databases containing data that is common across dealerships;
wherein the dealership databases contain data that is specific to a particular dealership;
wherein the common databases comprise a media database and a third party application support database; and
wherein each dealership implements its own dealership database to ensure complete separation of all business data from other dealerships.

49. The method of claim 47, wherein each ad is associated with a particular campaign; and
wherein each campaign is assigned a campaign code.

50. The method of claim 49, wherein the campaign code is used to link prospective buyers to the ads that introduced them to the dealership.

51. The method of claim 49, wherein each prospective buyer is assigned a customer identifier; and
wherein the campaign codes and prospect events are stored in the dealership database and linked by the customer identifiers.

52. The method of claim 47, wherein to create a new ad, the user selects a campaign, selects the vehicles to be included in the ad, selects an ad contact, specifies a time period over which an ad is to be run, enters an estimated cost for the ad, enters comments and/or instructions regarding production of the ad, and saves the ad as a new ad.

53. The method of claim 52, wherein once the new ad is saved, it is written to the dealership database;
wherein when a new ad is saved, a new ad message is automatically generated and posted to a web messaging page;
wherein when a new ad is saved, an ad identifier and a new ad message identifier are automatically generated; and
wherein when a new ad is saved, an email is automatically sent to the ad contact with the address for the web messaging page on which the new ad message is posted.

54. The method of claim 53, wherein a web messaging page is created for each new ad;
wherein the ad comprises contents and a design, and wherein the web messaging page allows the user and the ad contact to communicate with each other regarding the ad contents and design by posting messages to the web messaging page;
wherein the ad identifier and the new ad message identifier are used to generate the address for the web messaging page; and
wherein all messages concerning the ad are assigned identifiers related to the new ad message identifier and stored in the dealership database.

55. The method of claim 53, wherein the new ad message comprises a campaign code, the address for the web messaging page, an estimated cost of the new ad, and comments and/or instructions regarding the contents and/or design of the ad; and
wherein a file comprising a list of the vehicles to be included in the ad is attached to the new ad message.

56. The method of claim 55, wherein the marketing and/or sales materials from manufacturers are attached to the new ad message.

57. The method of claim 53, wherein the ad contact reviews the new ad message, produces a proof of the ad, and posts a message with the proof attached to the message on the web messaging page;
wherein the user reviews and approves or declines the proof, and if the proof is declined, provides reasons for declining;
wherein an iterative process continues until the ad is approved;
wherein when the ad is approved, if the ad contact is a media vendor, then an email with the approved proof is sent to the ad contact; and
wherein when the ad is approved, if the ad contact is not a media vendor, then an approval notification is sent to the ad contact and an email with the approved proof is sent to a contact at the media vendor for publication or airing of the ad.

58. The method of claim 57, further comprising providing a new budget entry page,
wherein when an ad is approved, an approval date is automatically assigned to the ad;
wherein the estimated cost of the ad and the approval date are modifiable;
wherein the user enters a total budgeted amount for advertising on the new budget entry page;
wherein the cost of ads whose approval dates are within a dealership's fiscal year are deducted from the total budgeted amount to generate a net amount; and
wherein the net amount is reflected on a campaign summary page of the campaign development module.

59. The method of claim 49, wherein a cost is associated with each campaign, and wherein the cost of a campaign is calculated by querying the dealership database for all ads associated with a particular campaign code.

60. The method of claim 59, wherein the user has the ability to calculate the costs associated with one or more campaigns by media, media type and/or vendor.

61. The method of claim 49, wherein the dealership has the ability to link customers to prospect events, customers to campaign codes, campaign codes to ads, ads to advertising costs, and campaign codes to media/type/vendor data; and
wherein the media data represents the media in which an ad appears, the type data is a sub-class of media, and the vendor data reflects the media vendor.

62. The method of claim 47, wherein the campaign development module comprises a campaign summary page;
wherein a media vendor is associated with each campaign, and wherein the campaign summary page identifies the media vendor;
wherein the campaign summary page identifies a media type, campaign code, vendor contact and dealership location for each campaign;
wherein the user can create a new campaign, edit an existing campaign, create a new ad, or delete a campaign from the campaign summary page;
wherein if the user elects to create a new campaign, a new campaign process is called;
wherein the new campaign process assists users in defining new campaigns; and
wherein the new campaign process comprises one or more pages that guide the user through the definition of a new campaign.

63. The method of claim 47, wherein the ad development module comprises an ad list page;
wherein the ad list page lists all ads that have been approved;
wherein users can screen ads by start and end dates and/or ad status; and
wherein ad status is current, pending or expired.

64. The method of claim 53, wherein the ad development module comprises an ad list page and an ad details page;
wherein the campaign development module comprises a campaign summary page;
wherein the ad details page is called when the user selects a specific ad on the ad list page or the campaign summary page;
wherein the ad details page comprises an ad details section, a dates and approvals section, a messaging section, and an inventory section; and
wherein the messaging section shows the initial new ad message from the dealership to the ad contact and all subsequent messages related to the initial new ad message.

65. The method of claim 47, wherein the ad development module comprises a new ad page;
wherein the new ad page assists users in defining new ads to be included in a campaign;
wherein the user selects vehicles to be included in the new ad;
wherein the vehicles are selected by search, from a cart and/or from inventory;
wherein the user inputs start and end dates for the new ad;
wherein the user associates the ad with a campaign;
wherein the user enters an estimated cost for the ad;
wherein the user selects an ad contact; and
wherein each ad comprises contents and/or design, the user enters comments and/or instructions concerning the contents and/or design of the ad.

66. The method of claim 65, wherein if the user elects to select vehicles from inventory, an inventory details page is called;
wherein the inventory details page comprises a cart section, a search section, a vehicle listing section, and a vehicle detail section; and
wherein the user can add vehicles to the cart from the inventory details page.

67. The method of claim 66, wherein the inventory details page displays a base cost and a manufacturer's suggested retail price for each vehicle;
wherein the inventory details page allows a user to input markup, rebate and discount amounts; and
wherein a sales price for the vehicle is calculated.

68. The method of claim 67, wherein the method further comprises providing a mini-desk calculation window that allows the user to calculate payment based on sales price, down payment and financing interest rate and term.

69. The method of claim 66, wherein the vehicle detail section comprises a valuation subsection and a profit center subsection;
wherein the valuation subsection displays vehicle valuation figures from third party sources; and
wherein the profit center subsection allows the user to calculate the potential profit associated with a particular transaction.

70. A method for developing and managing advertisement campaigns comprising:
(a) providing an ad development module;
(b) providing a campaign development module;
(c) providing an inventory control module;
(d) providing a messaging module;
(e) providing a prospect event tracking module; and
(f) providing a central data store;
wherein each module accesses the central data store;
wherein the central data store comprises data on products in inventory, existing customers, prospective buyers, advertisements and advertisement campaigns, contacts, communications, and marketing and/or sales materials from manufacturers;
wherein the campaign development module allows users to create new ad campaigns;
wherein the ad development module enables users to create new advertisements;
wherein the inventory control module allows a user to search for products that meet certain criteria and to view data on selected products;
wherein the messaging module manages communications within a sales entity, between the sales entity and customers, and between the sales entity and vendors; and
wherein the prospect event tracking module links prospective buyers to interactions with the sales entity.

71. The method of claim 70, wherein the central data store comprises an administration database, one or more sales entity databases, and one or more databases containing data that is common across sales entities;
wherein the sales entity databases contain data that is specific to a particular sales entity;
wherein the common databases comprise a media database and a third party application support database; and
wherein each sales entity implements its own sales entity database to ensure complete separation of all business data from other sales entities.

72. The method of claim 70, wherein each ad is associated with a particular campaign; and
wherein each campaign is assigned a campaign code.

73. The method of claim 72, wherein the campaign code is used to link prospective buyers to the ads that introduced them to the sales entity.

74. The method of claim 72, wherein each prospective buyer is assigned a customer identifier; and
wherein the campaign codes and prospect events are stored in the sales entity database and linked by the customer identifiers.

75. The method of claim 70, wherein to create a new ad, the user selects a campaign, selects the products to be included in the ad, selects an ad contact, specifies a time period over which an ad is to be run, enters an estimated cost for the ad, enters comments and/or instructions regarding production of the ad, and saves the ad as a new ad.

76. The method of claim 75, wherein once the new ad is saved, it is written to the sales entity database;
wherein when a new ad is saved, a new ad message is automatically generated and posted to a web messaging page;
wherein when a new ad is saved, an ad identifier and a new ad message identifier are automatically generated; and
wherein when a new ad is saved, an email is automatically sent to the ad contact with the address for the web messaging page on which the new ad message is posted.

77. The method of claim 76, wherein a web messaging page is created for each new ad;
wherein the ad comprises contents and a design, and wherein the web messaging page allows the user and the ad contact to communicate with each other regarding the ad contents and design by posting messages to the web messaging page;
wherein the ad identifier and the new ad message identifier are used to generate the address for the web messaging page; and
wherein all messages concerning the ad are assigned identifiers related to the new ad message identifier and stored in the sales entity database.

78. The method of claim 76, wherein the new ad message comprises a campaign code, the address for the web messaging page, an estimated cost of the new ad, and comments and/or instructions regarding the contents and/or design of the ad; and
wherein a file comprising a list of the products to be included in the ad is attached to the new ad message.

79. The method of claim 78, wherein the marketing and/or sales materials from manufacturers are attached to the new ad message.

80. The method of claim 76, wherein the ad contact reviews the new ad message, produces a proof of the ad, and posts a message with the proof attached to the message on the web messaging page;
wherein the user reviews and approves or declines the proof, and if the proof is declined, provides reasons for declining;
wherein an iterative process continues until the ad is approved;
wherein when the ad is approved, if the ad contact is a media vendor, then an email with the approved proof is sent to the ad contact; and
wherein when the ad is approved, if the ad contact is not a media vendor, then an approval notification is sent to the ad contact and an email with the approved proof is sent to a contact at the media vendor for publication or airing of the ad.

81. The method of claim 80, further comprising providing a new budget entry page,
wherein when an ad is approved, an approval date is automatically assigned to the ad;
wherein the estimated cost of the ad and the approval date are modifiable;
wherein the user enters a total budgeted amount for advertising on the new budget entry page;
wherein the cost of ads whose approval dates are within a sales entity's fiscal year are deducted from the total budgeted amount to generate a net amount; and
wherein the net amount is reflected on a campaign summary page of the campaign development module.

82. The method of claim 72, wherein a cost is associated with each campaign, and wherein the cost of a campaign is calculated by querying the sales entity database for all ads associated with a particular campaign code.

83. The method of claim 82, wherein the user has the ability to calculate the costs associated with one or more campaigns by media, media type and/or vendor.

84. The method of claim 72, wherein a sales entity has the ability to link customers to prospect events, customers to campaign codes, campaign codes to ads, ads to advertising costs, and campaign codes to media/type/vendor data; and
wherein the media data represents the media in which an ad appears, the type data is a sub-class of media, and the vendor data reflects the media vendor.

85. The method of claim 70, wherein the campaign development module comprises a campaign summary page;
wherein a media vendor is associated with each campaign, and wherein the campaign summary page identifies the media vendor;
wherein the campaign summary page identifies a media type, campaign code, vendor contact and sales entity location for each campaign;
wherein the user can create a new campaign, edit an existing campaign, create a new ad, or delete a campaign from the campaign summary page;
wherein if the user elects to create a new campaign, a new campaign process is called;
wherein the new campaign process assists users in defining new campaigns; and
wherein the new campaign process comprises one or more pages that guide the user through the definition of a new campaign.

86. The method of claim 70, wherein the ad development module comprises an ad list page;
wherein the ad list page lists all ads that have been approved;
wherein users can screen ads by start and end dates and/or ad status; and
wherein ad status is current, pending or expired.

87. The method of claim 76, wherein the ad development module comprises an ad list page and an ad details page;
wherein the campaign development module comprises a campaign summary page;
wherein the ad details page is called when the user selects a specific ad on the ad list page or the campaign summary page;
wherein the ad details page comprises an ad details section, a dates and approvals section, a messaging section, and an inventory section; and
wherein the messaging section shows the initial new ad message from the sales entity to the ad contact and all subsequent messages related to the initial new ad message.

88. The method of claim 72, wherein the ad development module comprises a new ad page;
wherein the new ad page assists users in defining new ads to be included in a campaign;
wherein the user selects products to be included in the new ad;
wherein the products are selected by search, from a cart and/or from inventory;
wherein the user inputs start and end dates for the new ad;
wherein the user associates the ad with a campaign;
wherein the user enters an estimated cost for the ad;
wherein the user selects an ad contact; and
wherein each ad comprises contents and/or design, the user enters comments and/or instructions concerning the contents and/or design of the ad.

89. The method of claim 88, wherein if the user elects to select products from inventory, an inventory details page is called;
wherein the inventory details page comprises a cart section, a search section, a product listing section, and a product detail section; and
wherein the user can add products to the cart from the inventory details page.

90. The method of claim 89, wherein the inventory details page displays a base cost and a manufacturer's suggested retail price for each product;
wherein the inventory details page allows a user to input markup, rebate and discount amounts; and
wherein a sales price for the product is calculated.

91. The method of claim 90, wherein the method further comprises providing a mini-desk calculation window that allows the user to calculate payment based on sales price, down payment and financing interest rate and term.

92. The method of claim 89, wherein the product detail section comprises a valuation subsection and a profit center subsection;
wherein the valuation subsection displays product valuation figures from third party sources; and
wherein the profit center subsection allows the user to calculate the potential profit associated with a particular transaction.
